(19) United States
(12) Patent Application Publication
(10) Pub. No.: US 2004/0068521 A1
(43) Pub. Date: Apr. 8, 2004

(54) Individual and user group webware for information sharing over a network among a plurality of users

(76) Inventors: E. Mark Haacke, Detroit, MI (US); Yingbiao Xu, Champaign, IL (US)

Correspondence Address: THOMPSON COBURN, LLP, ONE US BANK PLAZA, SUITE 3500, ST LOUIS, MO, 63101, US

(21) Appl. No.: 10/264,459

(22) Filed: Oct. 4, 2002

(51) Int. Cl. G06F 12/00

(52) U.S. Cl. 707/200

(57) ABSTRACT

A computer system for sharing information among a plurality of users, the computer system comprising: (a) a database having content stored therein, the content comprising (1) a plurality of data objects and (2) a user-configurable tree structure comprising a plurality of selectable nodes that index the data objects; (b) at least one client computer in communication with a global computer network, each client computer having a display screen on which the client computer is configured to display data to a user; (c) an application server in communication with the database and the network, the application server being configured to (1) send at least a portion of the tree structure over the network to a client computer at least partially in response to an access request received over the network from a client computer, (2) cause the client computer to display the tree structure sent thereto in a viewing frame of the client computer's display screen, (3) receive node selection input from the client computer that corresponds to a selection of a node of the displayed tree structure by the user of the client computer, (4) provide the data object indexed by the selected node to the client computer for display thereon in another viewing frame of the client computer's display screen, wherein both of the viewing frames are co-displayed on the client computer's display screen; (5) receive modification input from the client computer that corresponds to a modification of the content of the database including the tree structure, and (6) process the received modification input to thereby appropriately modify the content of the database.

### FIELD OF THE INVENTION

The present invention is related to the field of database sharing. More specifically, the present invention relates to how information stored in a database may be shared by a plurality of users via a computer network.

### BACKGROUND OF THE INVENTION

In today's electronic information age, the ability of multiple users, who may be separated geographically by distances both large and small, but linked by common interests, to conveniently share information over networks such as the internet is highly valuable. Further, given the diverse population of today's computer users, many of whom can be best characterized as casual computer users, one of the most important aspects of data sharing systems and software are their degrees of user-friendliness. Not only will such user-friendly systems and software bring the power of the Internet to casual computer users, but they will also attract the computer savvy, as even knowledgeable computer users prefer user-friendliness over unnecessary inconvenience. However, to maintain the interest of such knowledgeable computer users, such user-friendly systems and software must also possess sufficient capabilities and flexibilities to meet the demands of such knowledgeable computer users.

As such, there is a need in the art for a user-friendly and flexible technique of sharing information among a plurality of users over a computer network. Previous systems, while serving their purpose, have failed to fully satisfy the dual needs of simplicity and flexibility. Many web-based companies, such as Yahoo and Lycos, provide services where computer users can upload files via the Internet to a database maintained by that company. Thereafter, that company's servers interface users with their files stored in the database. Through the company's server, computer users are often given various file management capabilities (directory building, file naming, etc.).

For example, Yahoo, through its Geocities website, provides a service that allows users to view a list of hyperlinks that link the user to the files that have been uploaded to the database. By selecting a hyperlink, a user is linked to a new page that displays the contents of the file associated with the hyperlink. Users are also given file management capabilities and group management capabilities. Not only can a user name the hyperlinks associated with the files, but a user can also create directories and subdirectories. Thereafter, users can organize the hyperlinks hierarchically into various directories and subdirectories.

While systems such as the Geocities website certainly provide the basics for data sharing over the Internet, they suffer from the rigid structure of their organizational trees, and their inconvenient manners of presentation.

### SUMMARY OF THE INVENTION

In an effort to fill the need in the art for a user-friendly and flexibly powerful data sharing tool, the inventors herein have developed a computer system for sharing information among a plurality of users, the computer system comprising: (a) a database having content stored therein, the content comprising (1) a plurality of data objects and (2) a user-configurable tree structure comprising a plurality of selectable nodes that index the data objects; (b) at least one client computer in communication with a global computer network, each client computer having a display screen on which the client computer is configured to display data to a user; and (c) an application server in communication with the database and the network, the application server being configured to (1) send at least a portion of the tree structure over the network to a client computer at least partially in response to an access request received over the network from a client computer, (2) cause the client computer to display the tree structure sent thereto in a viewing frame of the client computer's display screen, (3) receive node selection input from the client computer that corresponds to a selection of a node of the displayed tree structure by the user of the client computer, (4) provide the data object indexed by the selected node to the client computer for display thereon in another viewing frame of the client computer's display screen, wherein both of the viewing frames are co-displayed on the client computer's display screen; (5) receive modification input from the client computer that corresponds to a modification of the content of the database including the tree structure, and (6) process the received modification input to thereby appropriately modify the content of the database.

Because the viewing frames used for displaying the tree structure and the data object corresponding to the selected node share the client computer's display screen, users of the present invention are able to navigate among the data objects indexed by the nodes of the tree structure in a manner that not only provides a non-congested viewing area but also allows users to view other data objects with a minimum of effort. Whereas conventional data sharing systems utilize pop-up windows for viewing requested data objects (which require users to manipulate the location and size of the pop-up window in order to view the data objects in an uncongested manner), the present invention utilizes non-overlapping viewing frames to display both the tree structure and requested data object to greatly simplify the user's ability to view the data object displayed in the data object viewing frame and request another data object by selecting a node in the tree structure viewing frame.

Further, to provide users with management control over their data to a degree unknown in prior art systems, the present invention provides users with wide-ranging abilities to add data objects to the database and/or modify the tree structure. The power to manage the data stored in the database includes at least one of the group consisting of (1) allowing a user to add one or more nodes to the tree structure, (2) allowing a user to add data objects to the database, (3) allowing a user index a data object with a node by associating the data object with its indexing node, (4) editing node attributes (such as the name of a node), and (5) allowing a user to upload commentary on the data objects to the database such that other users when viewing a data object may also view any commentary that a user has provided with respect to that data object.

Further still, the present invention provides users with a wide range of control over how the tree structure is displayed in the tree structure viewing frame. Using the level selection feature of the present invention, the tree structure can be redisplayed in the tree structure viewing frame upon user request such that a selected node serves as either the root node (and where the redisplayed tree structure is limited to nodes that are descendants of the selected node within a number of generations equal to a user-specifiable level selection value that is associated with the selected node) or the focus node (and where the redisplayed tree structure shows all descendant nodes and direct ancestor nodes (parents, grandparents, great-grandparents, etc.) within a number of generations equal to the selected node's user-specifiable level selection value). This feature of the present invention allows a user to focus the tree structure on nodes of interest, and is especially advantageous for increasing the user-friendliness of the tree structure when the tree structure includes many branches having many generations of nodes descending therefrom. Also, this feature represents an improvement over prior art systems that redisplay the tree structure starting from the root node wherein only a fixed, non-modifiable number of generations (typically either one generation or all generations) of descendant nodes are displayed.

The invention may also be provided with a “superpassword” feature. When the invention is used by several different groups to share data among the members of the respective groups, some users may be members of more than one group. In such cases, it is conventionally necessary for such a user to provide a memberID and password to authenticate his/her identity prior to accessing the group's data. However, it is often the case that such users will have different memberIDs and passwords for each of his/her groups, and remembering such a myriad of memberIDs and passwords can be a challenging task. To overcome this problem, the present invention allows users who are members of more than one group to use a single “superpassword” to access each of the groups of which that user is a member.

The present invention is highly suitable for sharing medical information such as magnetic resonance imaging (MRI) files among a plurality of spatially-separated medical personnel. Another highly suitable application for the present invention is for family members to share genealogical information with each other, wherein the tree structure is used to represent a family tree, wherein each node represents a different family member, and wherein each data object indexed thereby includes pertinent information specific to that family member (i.e., vital statistics, a photo, etc.).

These and other advantages of the present invention will be readily recognizable to persons of ordinary skill in the art upon review of the teachings herein.

### BRIEF DESCRIPTION OF THE DRAWINGS

FIG. 1 depicts an overview of the data sharing system of the present invention;

FIG. 2 is a table illustrating the relationship between groups, members and trees;

FIG. 3 is a flowchart illustrating the algorithm for logging in to the data sharing system of the present invention;

FIG. 4 is a client computer screen shot for displaying the tree structure and a data object;

FIG. 5 illustrates a node array with node fields;

FIG. 6 is a flowchart illustrating a tree display algorithm of the present invention;

FIG. 7 is a flowchart illustrating an algorithm for displaying the nodes of the tree structure hierarchically;

FIG. 8 is a flowchart illustrating an algorithm for redisplaying the tree structure in response to a selection of an arrow icon;

FIG. 9 is a flowchart illustrating an algorithm for redisplaying the tree structure in response to a selection of a display level icon;

FIG. 10 is a flowchart illustrating an algorithm for redisplaying the tree structure in response to a selection of a folder icon;

FIG. 11 is a table illustrating the association between nodes and data objects;

FIG. 12 is a table illustrating the association between nodes and comments;

FIG. 13(a) is a flowchart illustrating an algorithm for displaying a data object;

FIG. 13(b) is a flowchart illustrating an algorithm for displaying a data object having an HTML file type;

FIG. 13(c) is a flowchart illustrating an algorithm for displaying a data object having an image file type;

FIG. 13(d) is a flowchart illustrating an algorithm for displaying a data object having an image collection file type;

FIG. 13(e) is a flowchart illustrating an algorithm for displaying a data object having an other file type;

FIG. 14 is a client computer screen shot for adding one or more nodes to the tree structure;

FIG. 15 is a flowchart illustrating an algorithm for adding node(s) to the tree structure;

FIG. 16 is a client computer screen shot for associating a data object with a node;

FIG. 17 is a flowchart illustrating an algorithm for associating a data object with a node and uploading that data object to the database;

FIG. 18 is a client computer screen shot for associating a comment with a node;

FIG. 19 is a flowchart illustrating an algorithm for associating a comment with a node and uploading the comment to the database;

FIG. 20 is a client computer screen shot for editing the fields of a node;

FIG. 21 is a flowchart illustrating an algorithm for editing a node;

FIG. 22 is a table illustrating the relationship between members and super passwords;

FIG. 23 is a flowchart illustrating an algorithm for logging on to a system configured with a super password function;

FIG. 24 is a client computer screen shot for initially accessing the system of the present invention;

FIG. 25 is a flowchart illustrating an algorithm for adding a new group to the database;

FIG. 26 is a flowchart illustrating an algorithm for registering a new member to a group;

FIG. 27 is a node array with node fields wherein there is an additional field to identify whether the node is fixed or unfixed;

FIG. 28 is a client computer screen shot of the tree structure viewing frame wherein the tree structure includes fixed and unfixed nodes; and

FIGS. 29(a)-(c) are client computer screenshots of examples of root node and focus node modes of the level selection control aspect of the present invention.

### DETAILED DESCRIPTION OF THE PREFERRED EMBODIMENT

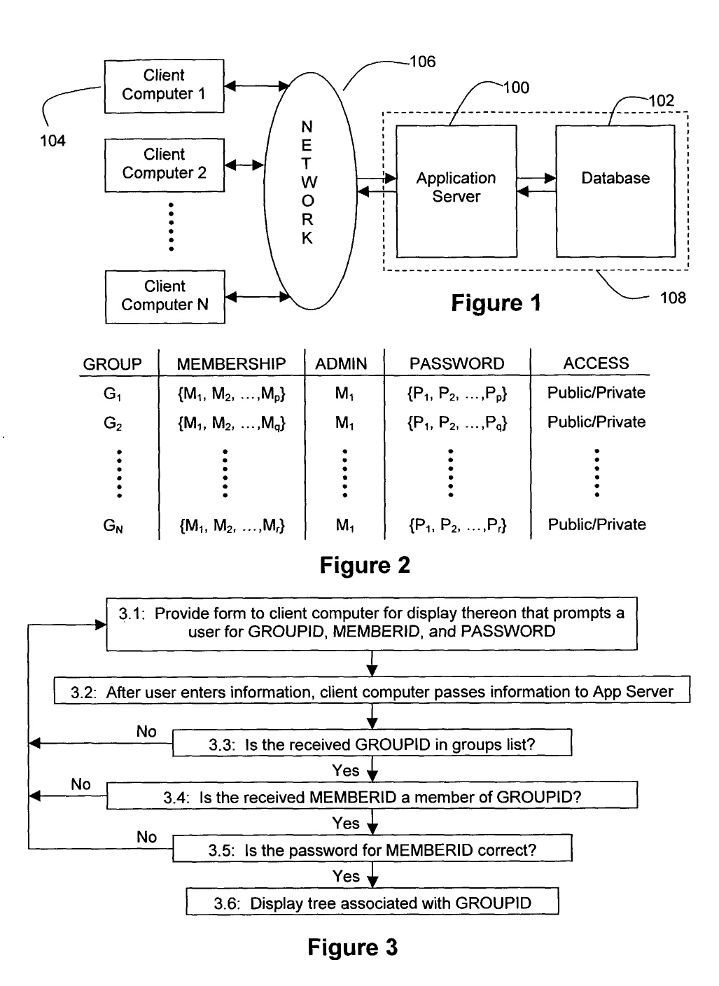

FIG. 1 illustrates a preferred topology for the data sharing system of the present invention. Preferably, the data sharing system is implemented as a three-tier client/server architecture model. An application server 100 controls access to the contents of database 102. Various client computers 104 can interact with the application server 100 via network 106. Together, the application server 100 and database 102 act as a data access provider 108. It should be noted that the data access provider can be a home PC with web server software installed thereon.

FIG. 2 is a table illustrating the relationship between various data sharing groups, its members, and its tree structure. As can be seen from the table in FIG. 2, each group will have an associated membership list. This membership list will identify the members of the group. Each group will also have one of these members identified as the group administrator. Group administrators will be provided with additional controls over the group, such as the ability to add new members, etc. The members of each group will also have a password associated with them. A member will have to supply such a password to gain access to the group's tree structure. The tree structure associated with a group will be an array of nodes, N_{G1}(j,k) wherein j is the row index for the array and k is the column index for the array. Each node may potentially have a data object associated therewith. Also, each group can be designated as either public or private. For groups that are designated public, new users can gain access to the group's data by registering themselves. No restrictions are placed on who may register. If the group is designated as private, a user can only gain access to the group's data if the administrator of that group has added that user to the group's membership list.

FIG. 3 illustrates an algorithm for logging in to the data sharing system of the present invention. Steps 3.1 through 3.6 of FIG. 3 disclose the various steps involved in restricting access to data to registered members who supply the proper password. Upon successfully providing the proper GroupID, MemberID, and password, the user gains access to the group's data stored in the database.

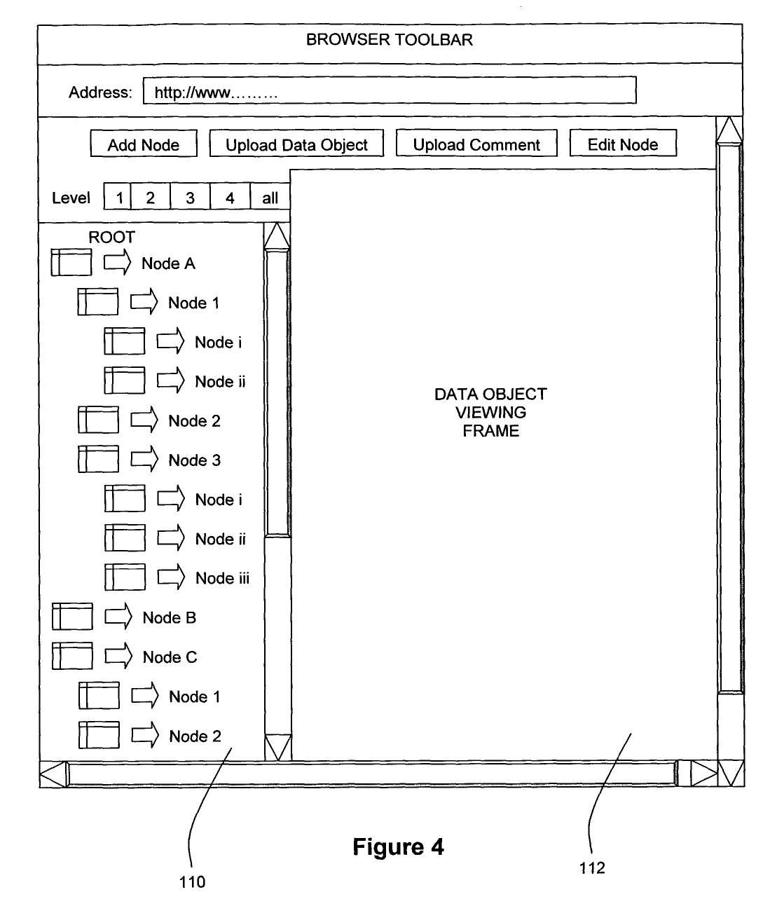

FIG. 4 is a client computer screen shot illustrating the displayed tree structure. The tree structure is shown in the tree structure viewing frame 110. As can be seen, the tree structure is comprised of a plurality of hierarchically organized nodes. Preferably a folder icon and an arrow icon will be adjacent to each node having a descendant node. The folder icon will be selectable to either display or hide all nodes that are children of the node adjacent to the selected folder icon. The arrow icon is selectable to re-display the tree structure using the node adjacent to the selected arrow icon as either (1) a root node from which descendant nodes within a user-defined number of generations are displayed or (2) a focus node from which descendant nodes and direct ancestor nodes (parents, grandparents, great-grandparents, etc.) within a user-defined number of generations are displayed. Toward this end, each arrow icon has an associated level control variable which controls how many generations of descendant nodes (in the root node case) or how many generations of direct ancestors and descendants (in the focus node case) are to be displayed from the node adjacent to the selected arrow icon. If a node has no nodes descending therefrom, it is preferable that no folder icon or arrow icon be shown alongside that node.

To display the tree structure, the tree structure viewing frame 110 is divided into rows and columns. Each row contains a node, and the column in which the node is displayed will depend upon the order of the node. The tree structure's root is classified as being of Order 0. All nodes having the root as a parent are classified as first order. All nodes having first order nodes as parents are classified as second order, and so on for lower ordered nodes. Order 1 nodes are displayed in the leftmost column. Second order nodes are displayed one column to the right of the leftmost column, and lower order nodes are successively displayed in columns incremented to the right. In doing so, the hierarchical organization of the tree structure is clearly apparent. While the tree structure is displayed in the tree structure viewing frame 110, the client computer will also display a viewing frame 112 in which the data object associated with a selected node is displayed. Each node of the tree structure is selectable by a user (preferably by using a mouse to move a cursor over the node and clicking the mouse) to thereby display the data object associated therewith. In addition to displaying the nodes hierarchically by order, the nodes of the tree structure can also be displayed chronologically (by date of the node's creation) or alphabetically (by the alphabetical order of each node's name). To display nodes in chronological order (which may be either reverse chronological order or forward chronological order), each node should have a field associated therewith that identifies when that node was created.

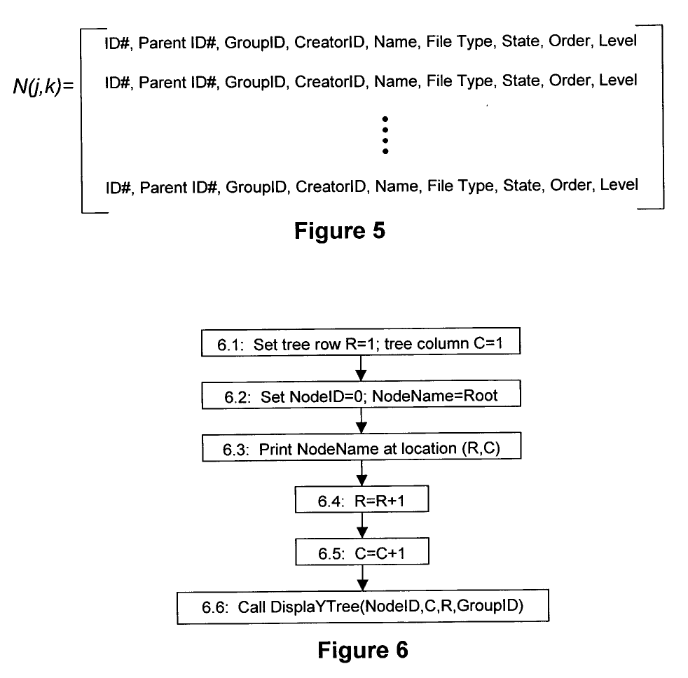

Nodes of the tree structure are stored in an array indexed by the rows and columns of the array. Each node is stored in a different row of the array, and each field of the node exists in a different column. FIG. 5 illustrates the node array. The fields of the nodes are as follows: ID# (which is a serial number that uniquely identifies each node), parent ID# (which is the unique serial number of the node's parent), GROUP ID (which identifies the group with which the node is associated), CREATOR ID (which identifies the member of the group that created the node), name (which identifies the name of the node that his displayed), file type (which identifies a file type for the data object associated with a node—examples of file types that can be used in connection with the present invention are HTML files, image files (such as JPEG images), image collections (multiple images), and others, state (which may exist in either an on state or an off state, the on state meaning that the node will be shown on the tree structure, and the off state meaning that the node will be hidden in the tree structure), order (which identifies the node's order in the tree structure), and level (which identifies how many descendant generations of the node are to be displayed when the node's arrow icon is selected).

FIG. 6 illustrates the algorithm for displaying the tree structure and the tree structure viewing frame. At Step 6.1, the row R and column C are both set to 1. At Step 6.2, the parameter NodeID is set to 0, and the parameter Node Name is set to root. Thereafter, at Step 6.3, the value of the parameter Node Name (root) is printed in the tree structure viewing frame at location (R,C). Thereafter, in Steps 6.4 and 6.5, the values of R and C are incremented. Thereafter, at Step 6.6, the no display algorithm is called. The parameters passed to the no display algorithm are NodeID, R, C and GroupID.

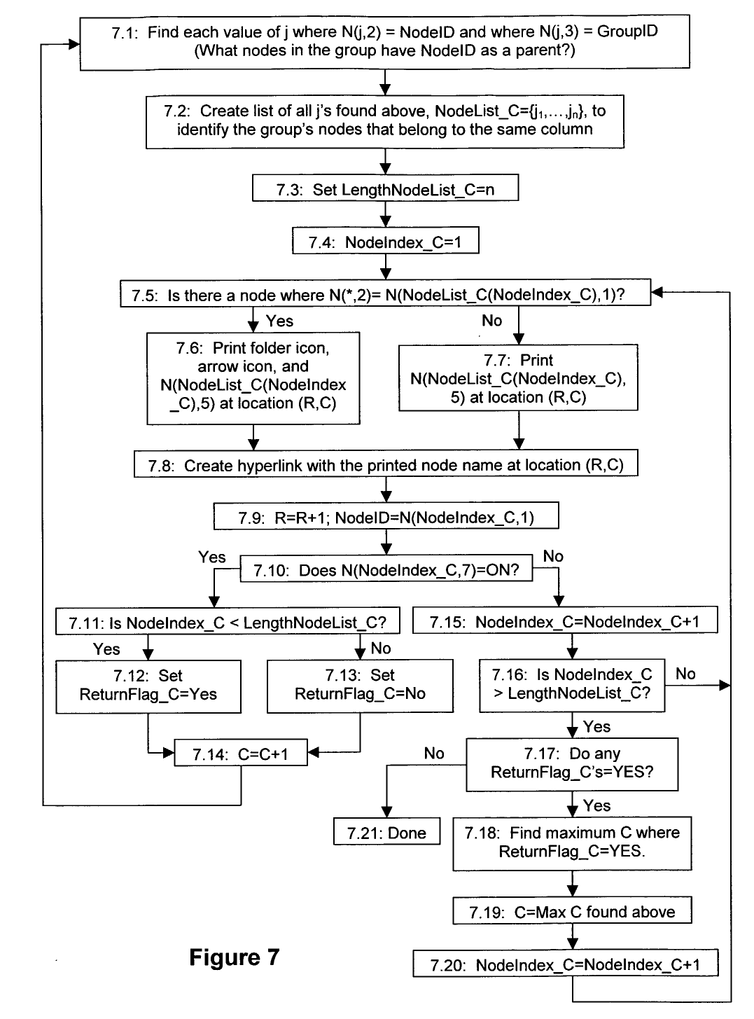

FIG. 7 illustrates the Node display algorithm. This algorithm is a top down depth first algorithm. At Step 7.1, the algorithm finds each value of J where N(j,2)=NodeID and N(j,3)=GroupID to thereby find all nodes in the group that have Node ID as the parent. In this case, Step 7.1 will find all of the nodes in the group that are children of the root node. Next, at Step 7.2, the algorithm creates a list of all of the Js found in Step 7.1. This list is stored as NodeList_C={j₁, . . . , jₙ}. Each list is indexed by the column C within which the nodes in the list are to be displayed. At Step 7.3, the parameter LengthNodeList_C is set equal to N (the number of Js in NodeList_C). Next, at Step 7.4, the parameter NodeIndex_C is set equal to 1. NodeIndex_C is used as a pointer to the Js stored in NodeList_C.

At Step 7.5, the algorithm checks whether there is a node where N(*,2) equals N(NodeList_C), 1). This step determines whether the node in the NodeList_C indexed by NodeIndex_C has a child. In doing so, it looks for any nodes in the node array having that node identified as a parent node. If the current node does have a child, then a folder icon and an arrow icon are to be printed along side the node in the tree structure. Thus, at Step 7.6, the algorithm prints a folder icon and arrow icon and the node's name—N(NodeList_C)(NodeIndex_C), 5 at location (R,C) in the tree structure viewing frame. If the current node does not have a child, then at Step 7.7 the algorithm prints only the node's name at location (R,C). Next, at Step 7.8, the algorithm creates a hyperlink with the printed Node Name. Then, at Step 7.9, the row value R is incremented, and the parameter Node ID is set equal to N(NodeIndex_C, 1).

Next, at Step 7.10, the algorithm checks the state of the current node (the value of N(NodeIndex_C,7)). If the current node's state is on, this means that the node's children are to be displayed. If the node's state is off, this means that the node's children are not to be displayed.

If the node's children are to be displayed, then the algorithm proceeds to Steps 7.11-14 before looping back to Step 7.1. At Step 7.11, the algorithm checks whether NodeIndex_C is less than the parameter LengthNodeList_C. If NodeIndex_C is less than NodeList_C, then the algorithm knows that there are still remaining nodes in the node list that will need to be processed. Thus, at Step 7.12, the parameter ReturnFlag_C is set to Yes. This parameter identifies whether the algorithm needs to return to column C's NodeList_C when the algorithm is finished processing a lower order node list. If the value of NodeIndex_C is equal to the value of the parameter LengthNodeList_C, then at Step 7.13, the algorithm sets the parameter RetumFlag_C equal to No. From both Steps 7.12 and 7.13, the algorithm proceeds to Step 7.14 where the value of C is incremented. After C is incremented, the algorithm loops back to Step 7.1 where the new value for the parameter NodeID is used to find each node that is a child of the current node. Such nodes are placed in a new NodeList_C array that is indexed by the incremented column. And from there, the process repeats itself.

If at Step 7.10, the algorithm finds that the current node's state is off, then at Step 7.15 the value of NodeIndex_C is incremented. Thereafter, at Step 7.16, the algorithm checks whether all j's in NodeList_C have been processed by comparing the current value of NodeIndex_C with the value of the parameter LengthNodeList_C. If NodeIndex_C is less than or equal to LengthNodeList_C, then the algorithm loops back to Step 7.5 and begins the process of processing the next node in NodeList_C.

If Step 7.16 results in a determination that all of the nodes in NodeList_C have been processed, then at Step 7.17, the algorithm checks whether any of the columns' ReturnFlag parameters equal Yes. If all of the ReturnFlags for each column have been set to No, then the algorithm knows that all nodes that are to be displayed on the tree structure have been processed. Thus, the algorithm proceeds to Step 7.20 which is the end of algorithm. However, if there is at least one return flag set equal to Yes, then at Step 7.8 the algorithm finds the maximum C where ReturnFlag_C equals Yes. The value of C will identify the column in which there are nodes that still need to be processed. Thus, at Step 7.9, the value of C will be set equal to the maximum value of C found in Step 7.18. Then at Step 7.20, the value of the parameter NodeIndex_C is incremented, and the algorithm then loops back to Step 7.5 where the node indexed in NodeList_C by NodeIndex_C is processed. Once all nodes that are to be displayed are processed, the algorithm will eventually reach Step 7.21 which indicates that all nodes to be displayed have been processed.

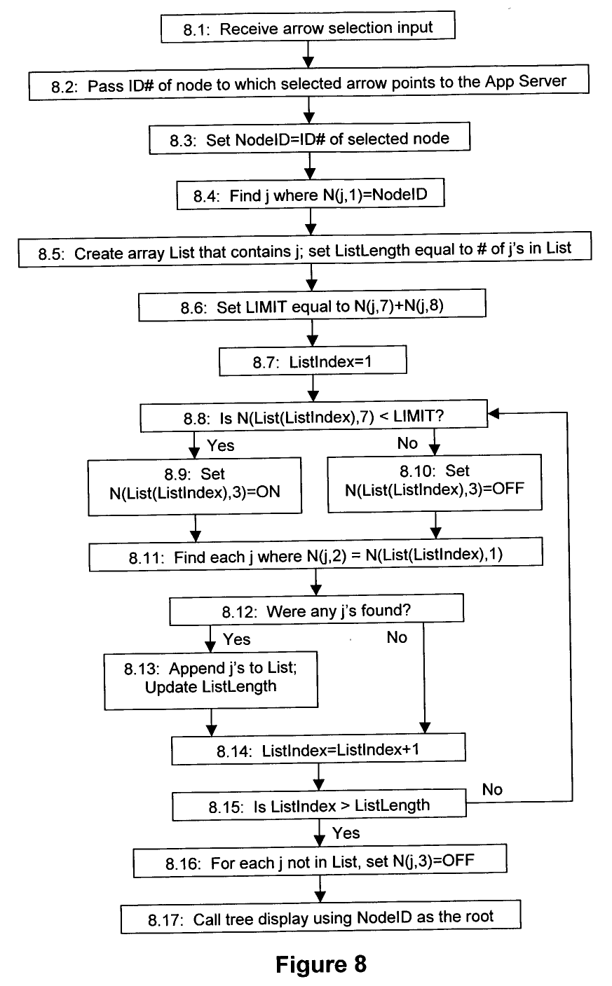

FIG. 8 is a flowchart identifying the algorithm for redisplaying the tree structure upon the selection of an arrow icon. When an arrow icon is selected, the tree structure will be redisplayed using the node to which the selected arrow icon points as the root node. At Step 8.1, the client computer receives the arrow selection input from a user. Next, at Step 8.2, the client computer passes the ID# of the node to which the selected arrow points to the application server. Thereafter, at Step 8.3 the application server sets the parameter Node ID equal to the ID# of the selected node. Then, at Step 8.4, the application server finds the value of j where N(j, 1) equals NodeID to find the row and the node array that includes the fields of the selected node. Next, at Step 8.5, the application server creates an array List that contains the j found in Step 8.4. The application server will also set the parameter ListLength equal to the number of j's in the array List (which in this case will be 1).

Next, at Step 8.6, the application server sets the parameter LIMIT equal to the sum of the node's order and level values (LIMIT=N(j,8)+N(J,9)). The value of the parameter LIMIT will identify the largest order value of nodes that are to be displayed. One of the features of the arrow icon, is that it is adjustable to control the number of descendant generations from the node associated with the selected arrow icon. Thus, if the selected node's level field is set to 3, and the selected node's order is 2, then 3 generations of descendant nodes are to be displayed, and the lowest order descendant will be a fifth order node. If the selected node's level field is changed to 5, then 5 generations of descendant nodes are to be displayed, with the lowest order descendant being a seventh order node.

At Step 8.7, the application server sets the parameter ListIndex equal to 1. ListIndex will serve to identify the node in the array List that is currently being processed by the algorithm. At Step 8.8, the algorithm checks whether the order of the node indexed by ListIndex is less than the parameter LIMIT. If the current node's order is less than LIMIT, then that node's children are to be displayed. Thus, at Step 8.9, the algorithm sets that node's state to on. If the current node's state is greater than or equal to LIMIT, then that node's children are not to be displayed, and at Step 8.10 the algorithm sets that node's state to off. From Steps 8.9 and 8.10, the algorithm proceeds to Step 8.11 and finds each j in the node array where N(j,2) equals N(List(ListIndex), 1) to thereby find each node that is a child of the current node. At Step 8.12 the algorithm checks whether any j's were found in Step 8.11. If any i's were found, at Step 8.13 the algorithm appends the found j's to the array List, and updates the value of the parameter ListLength to reflect the changes made to List. From Step 8.13 or from Step 8.12 if no j's were found at that step, the algorithm proceeds to Step 8.14 where the parameter ListIndex is incremented. Then, at Step 8.15, the algorithm checks whether ListIndex is greater than ListLength. If ListIndex is less than or equal to ListLength, then the algorithm loops back to Step 8.4 to process the next node in the array List. If the value of ListIndex is greater than the value of ListLength, then the algorithm knows that it has completed processing all of the nodes to be displayed in the tree structure. Next, at Step 8.16, the algorithm sets the state of each node not found in the array List equal to OFF, to thereby ensure that the display tree structure does not include any nodes that are not children of the selected node within the range specified by the arrow icon. Next, at Step 8.17, the algorithm calls the tree display algorithm of FIGS. 7 and 8 using the parameter NodeID (which has been set equal to the ID# of the node pointed at by the selected arrow icon) as the root node.

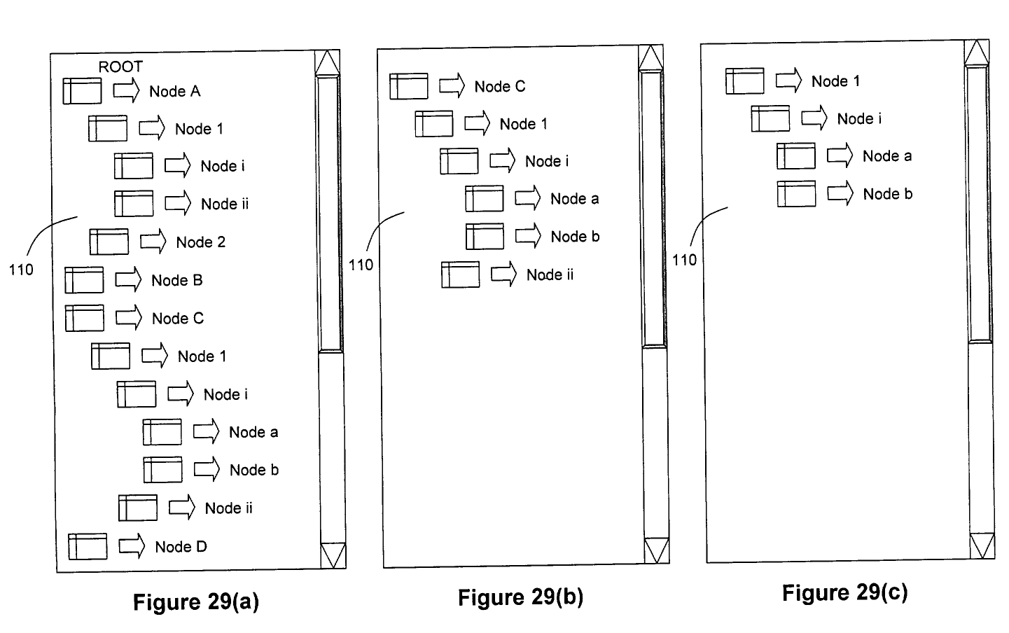

FIGS. 29(a) and 29(b) illustrate the results of arrow selection in the root node mode. FIG. 29(a) depicts a tree structure with several hierarchically organized nodes. Upon selection of an arrow icon for a node (say Node C), the tree structure is redisplayed using Node C as the root node. (See FIG. 29(b)). The number of generations below Node C that are displayed is adjustable by way of Node C's level parameter. As can be seen in FIG. 29(b), Node C is now shown as the root node, and three generations of nodes are shown descending from Node C.

It should also be pointed out that the arrow selection aspect of the present invention can also operate using the node of a selected arrow as a focus node rather than a root node. In this case, upon selection of a node's arrow icon, the tree structure is redisplayed using the selected arrow's node as a focus node from which an adjustable number of generations of ancestor nodes and descendant nodes are shown. FIGS. 29(a) and 29(c) illustrate this concept. If the arrow for Node I (descending from Node C) is selected, the tree structure of FIG. 29(c) will result if the focus node case is implemented and Node i's level parameter is 1. In FIG. 29(c), it can be seen that one generation of ancestor nodes and 1 generation of descendant nodes are displayed along with Node i.

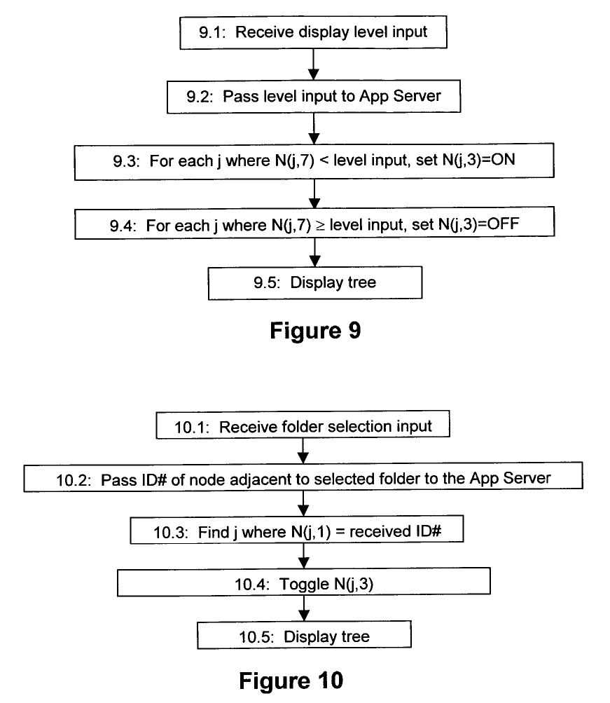

Returning to FIG. 4, the client computer will also display a number of icons for controlling the depth of levels displayed by the tree structure. These icons are shown in FIG. 4 adjacent to the text “Level” and may identify any number of levels for controlling the depth of nodes to be displayed on the tree structure. After a user selects a particular level, all nodes of the tree structure having an order within the range of the identified depth level will be displayed. FIG. 9 is a flowchart illustrating the algorithm for controlling the display level.

At Step 9.1, the client computer receives display level input from a user. At Step 9.2, the client computer passes this level input to the application server. At Step 9.3, for each j where N(j,8) is less than the level input provided by the user, the application server sets N(j,7) equal to on. Thus, only nodes having an order within the range specified by the level input will be displayed. At Step 9.4, for each j where N(j,8) is greater than or equal to the level input provided by the user, the application server sets N(j,7) equal to off. Thereafter, at Step 9.5, the application server calls the tree display algorithm of FIGS. 6 and 7.

The folder icons shows in FIG. 4 are also selectable by a user. By selecting a folder icon, a user toggles the state of the node adjacent to the folder. If the current tree structure displays descendants of the node adjacent to the selected folder, this means that the state of that node was previously ON. By selecting the folder icon, the state of that node is toggled to the OFF position, and the tree structure is redisplayed such that the descendants of the node adjacent to the selected folder icon are not displayed. If the current tree structure does not display any descendants of the node adjacent to the selected folder, this means that the state of that node is OFF, and by selecting the folder icon, the user toggles the state of that node to the ON position. Once the node's state is toggled ON, the children of the node are displayed. FIG. 10 illustrates the algorithm for this process.

At Step 10.1, the client computer receives folder selection input from a user. At Step 10.2, the client computer passes the ID# of the node adjacent to the selected folder to the application server. Next, at Step 10.3, the application server finds the j where N(j,1) equals the received ID#. Then, at Step 10.4, the application server toggles N(j,3) to thereby flip the state of the node. Then, at Step 10.5, the application server calls the tree display algorithm of FIGS. 6 and 7.

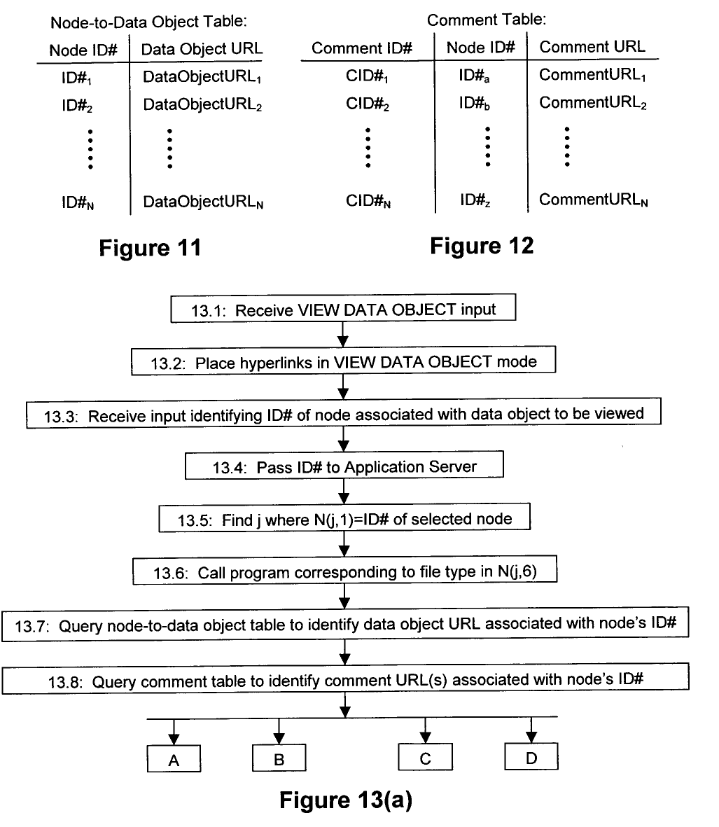

By selecting a node (for example by clicking upon the node's hyperlink name in the tree structure viewing frame) a data object that is associated with that node can be displayed in the viewing frame 112. FIG. 11 illustrates a table showing the relationship between nodes and their associated data objects. The node to data object table includes a column identifying a pointer to each data object stored in the database and a column listing the ID#s of the nodes in the Node array. Preferably, the data object pointer is a URL that identifies the location of the data object in the database. Upon the selection of a node in the tree structure, the application server can consult the node to data object table to identify the data object associated with that node.

However, it should be pointed out that it need not be the case that all data objects are stored in the application server database. The data objects can be stored on any server accessible via the Internet so long as the data object's URL is stored in the application server database. For example, if a client computer is configured to be accessible as a web server, a data object being made available to a group through the present invention can remain in the client computer's memory without being copied to the application server database if a URL for the data object is added to the application server's database.

The data sharing system of the present invention also supports the association of comments with stored data objects. If a user of the system wishes to comment upon a data object, that user can do so by entering the text of the comment and uploading the comment's text to the database. After storing comments in the database, the application server updates the comment table of FIG. 12. Each comment will have a unique serial number assigned thereto (CID#). The comment table will include columns of associated CIDs, NodeIDs and pointers to the comments.

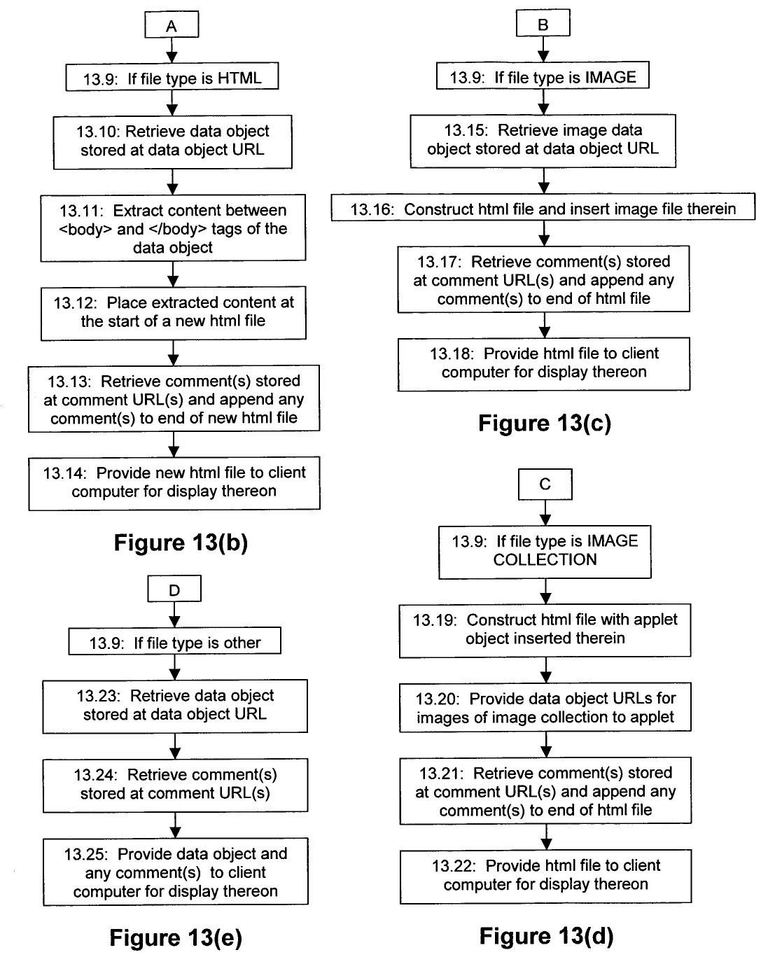

FIGS. 13(a-e) illustrate the algorithm for displaying a data object and any comments added thereto in the viewing frame 112 when a node associated therewith is selected by a user. At Step 13.1, the client computer receives VIEW DATA OBJECT input from a user, and at Step 13.2, the node hyperlinks are placed in the view data object mode. Thereafter, at Step 13.3, the client computer receives input identifying the ID# of the node associated with the data object to be viewed. As stated, preferably the user views the data object by clicking the node associated therewith in the tree structure. Then, at Step 13.4, the client computer passes the ID# of the selected node to the application server. Preferably, Steps 13.1 and 13.2 are not used, and the tree structure node hyperlinks are placed in the VIEW DATA OBJECT mode by default. However, if such a default setting is not used, a separate VIEW DATA OBJECT icon can be added to the toolbar to place nodes in the VIEW DATA OBJECT mode.

At Step 13.5, the application server finds the value of j where N(j,1) equals the ID# of the selected node. Then, at Step 13.6, the application server calls a program that corresponds to the file type identified by N(j,6). The program that corresponds to the node's file type is a program that is suitable for displaying the data object associated with the node. Next, at Step 13.7, the application server queries the node to data object table of FIG. 11 to identify the data object URL associated with the node's ID#. Thereafter, at Step 13.8, the application server queries the comment table to identify each comment URL that is associated with the node's ID#. Further steps of the algorithm depend upon the file type field of the selected node.

FIG. 13(b) depicts the algorithm where the file type is HTML. At Step 13.9, the application server retrieves the data object stored at the URL identified in Step 13.7. Then, at Step 13.10, the application server extracts the content of that data object between the <body>and </body>tags of the data object. At Step 13.11, the extracted content is placed at the start of a new HTML file, and then the application server retrieves each comment stored at each comment URL identified in Step 13.8 and appends each of those comments to the end of the new HTML file (Step 13.12). Finally, at Step 13.13, the application server provides that new HTML file to the client computer for display thereon in viewing frame 112.

FIG. 13(c) depicts the algorithm where the file type is Image. At Step 13.14, the application server retrieves the image data object stored at the URL identified in Step 13.7. At Step 13.16, the application server constructs an HTML file and inserts the retrieved image file therein. Thereafter, at Step 13.17, the application server retrieves each comment stored at the URL identified at Step 13.8, and appends any retrieved comments to the end of the HTML file. Finally, at Step 13.8, the application server provides that HTML file to the client computer for display thereon in viewing frame 112.

FIG. 13(d) depicts the flowchart where the file type is Image Collection. The Image Collection file type will be used to designate situations where a node is associated with a plurality of images and each image is to be displayed simultaneously in the viewing frame. At Step 13.19, the application server constructs an HTML with an applet object inserted therein. The applet will allow multiple images to be viewed simultaneously, and will allow a user to adjust the image's contrast, brightness, and zoom level. At Step 13.19, the application server provides the URLs for the image data objects found in Step 13.7 that make up the Image Collection to the applet. Next, at Step 13.21, the application server retrieves each comment stored at each URL identified in Step 13.8 and appends any such comments to the end of the HTML file. Finally, at Step 13.22, the application server provides the HTML file to the client computer for display thereon in viewing frame 112.

FIG. 13(e) depicts the algorithm where the file type is “Other”. At Step 13.23, the application server retrieves the data object stored at the URL found in Step 13.7. Next, at Step 13.23, the application server retrieves each comment stored at each comment URL identified in Step 13.8. Next, at Step 13.25, the application server provides the retrieved data object and any retrieved comments to the client computer for display thereon in viewing frame 112.

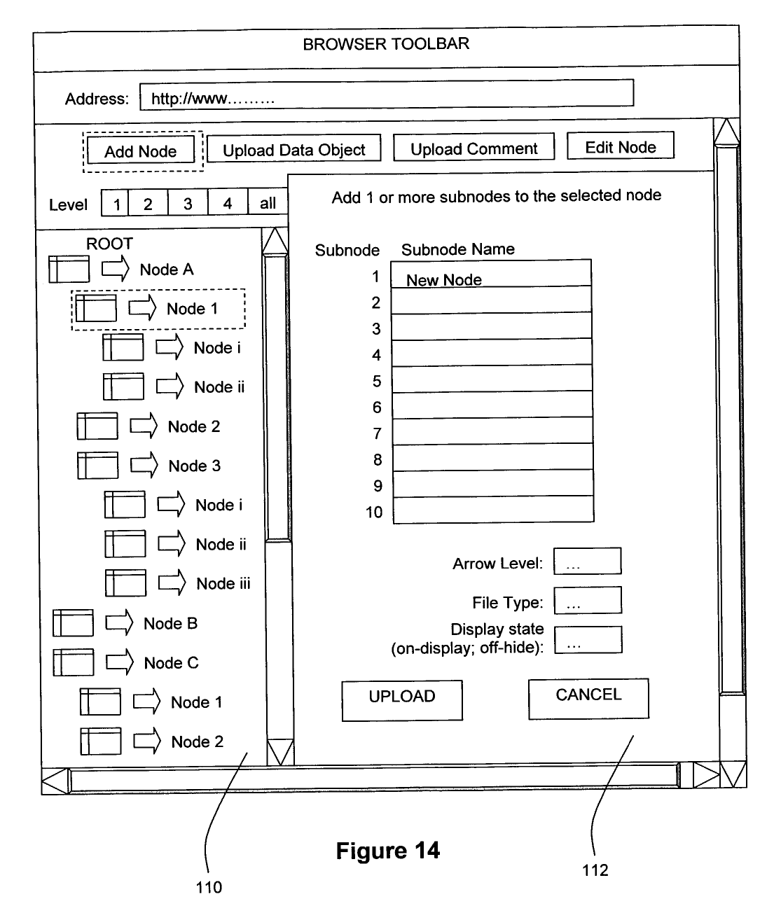

The data sharing system of the present invention also provides users with the ability to add nodes to the group's tree structure at user-specified locations. An ADD NODE icon will be displayed on the client computer for this purpose. Upon selecting the ADD NODE icon, a user can specify the location to add the new node by clicking upon the new node's parent to be. At this time, an interactive form is presented to the user in viewing frame 112. FIG. 14 illustrates this interactive form. The dashed boxes around the ADD NODE icon and the tree structure node labeled Node 1 beneath Node A indicate that these two icons have been selected by the user. After selection of the ADD NODE icon and the Node 1 icon, the form shown in viewing frame 112 is displayed. From this form, the user can specify various attributes for the new node to be added. Further, if the user so desires, a plurality of new nodes can be added as children to the selected node. The preferred user-specifiable fields for the node are node name, file type, arrow level, and display state. Other fields of the nodes are preferably nonmodifiable and will be known by the system; these nonmodifiable fields are parent node, GroupID, CreatorID, NodeID, and order. Once a user enters the desired fields via the interactive form, the user can save the new node to the database by selecting the UPLOAD icon. If the user has failed to enter a field for the new node, the system can either re-prompt the user to enter all fields for the new node, or it can simply set the unprovided fields to default values.

If so desired, the system can be configured such that upon the selection of the ADD NODE icon, the tree structure is redisplayed such that either only the nodes having the same CreatorID as the user's MemberID are shown, or such that only the nodes that have the same CreatorID as the user's MemberID are selectable. Such a configuration would restrict the ability of a user to add new nodes only under those nodes for which he is identified as the creator. In doing so, the present invention allows each user to have a personalized branch on the tree.

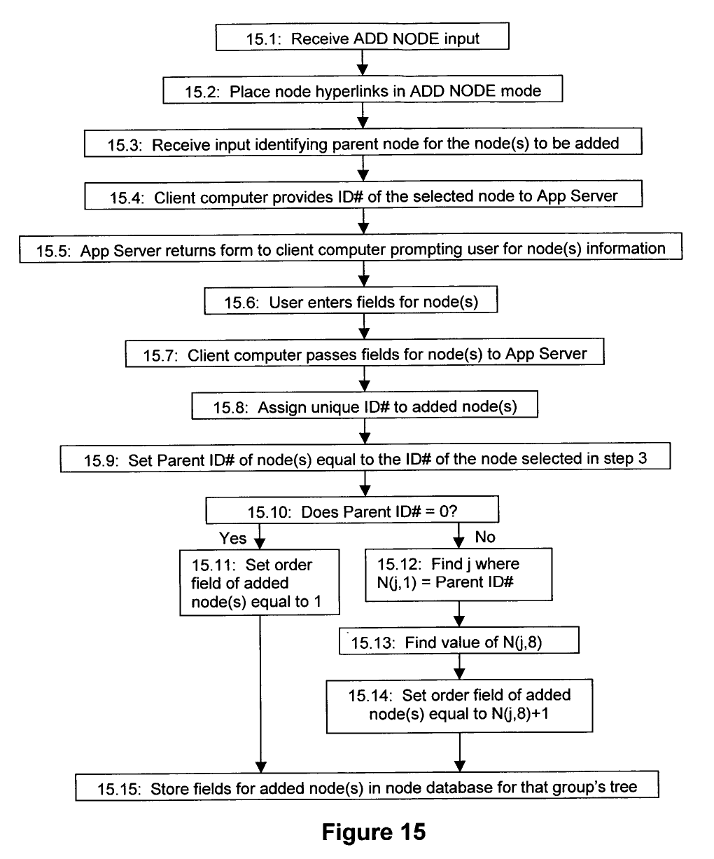

FIG. 15 is a flowchart illustrating the algorithm for adding a node to the tree structure. At Step 15.1, the client computer receives add node input from a user. As stated, the user can provide such input by clicking upon the ADD NODE icon on the client computer's screen. Thereafter, at Step 15.2, the client computer places the tree structure node hyperlinks in the ADD NODE mode. As stated above, if desired, the system can be configured such that the tree structure is redisplayed in a manner that restricts the ability of a user to add nodes beneath only particular nodes. At Step 15.3, the client computer receives input from the user that identifies the parent node for the new node (or nodes) to be added. As stated above, the user can provide such input by clicking upon the new node's parents to be. At Step 15.4, the client computer provides the ID# of the selected node to the application server.

Thereafter, at Step 15.5, the application server returns an interactive form to the client computer for display thereon in the viewing frame 112 that prompts the user for the node's information. An exemplary form is shown in viewing frame 112 in FIG. 14. Thereafter, after the user enters the requested fields for each new node (Step 15.6), the client computer passes those fields to the application server (Step 15.7).

After receiving the fields entered by the user, the application server, at Step 15.8, assigns a unique ID# to each added node. Next, at Step 15.9, the application server sets the field Parent ID# of each new node equal to the ID# received at Step 15.4. Thereafter, at Steps 15.10 through 15.15, the application server determines the value for the order field of each new node.

At Step 15.10, the parameter node order is set equal to 1. Then, at Step 15.11, the application server checks whether the new node's Parent ID# field equals 0. If it does equal 0, this means that the new node's order is 1. If the Parent ID# of the new node does not equal 0, then this means that the new node's order should be greater than 1. At Step 15.12, the application server sets the order field of each new node equal to 1. At Step 15.13, the application server finds a value of j where M(j, 1) equals Parent ID#. The j found in Step 15.13 will identify the parent node for the new node. Having found this parent node, at Step 15.14, the application server can check the order field of the parent node by finding the value of N(j,8). Then, at Step 15.15, the application server can set the order for each new node equal to the order of the parent node plus 1 (order of new node equals N(j,8)+1). Thereafter, at Step 15.16, the application server adds the fields of each new node to the node array in the database.

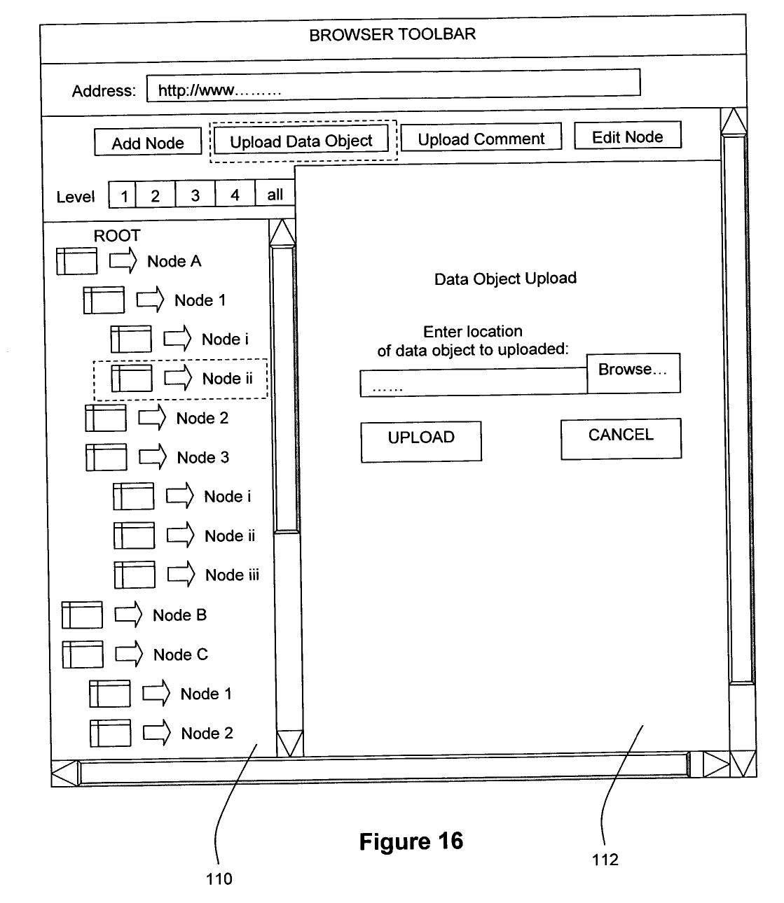

Another feature of the present invention is the ability of a user to associate a data object with a node on the tree structure. By associating a node with a data object, users can view the data object associated with a particular node by selecting that particular node in the tree structure viewing frame 110. To begin the process of associating a data object with a node, a user preferably selects an UPLOAD DATA OBJECT icon displayed on the client computer. Thereafter, after the user selects the node with which the data object is to be associated, (by selecting a particular node in the tree structure), an interactive form is displayed in viewing frame 112 that prompts the user to identify the data object to be associated with the selected node. This interactive form is shown in FIG. 16. The dashed box around the node labeled “Node ii” beneath node A indicates that Node ii has been selected for association with a data object. The dashed box around the UPLOAD DATA OBJECT icon indicates that a user has selected this icon to begin the node-to-data object association task. As with the node addition process, the ability of a user to associate data objects with a node can be restricted to only those nodes having the same CreatorID field as the user's MemberID. Doing so will ensure that a user only associates data object with nodes that he or she has created.

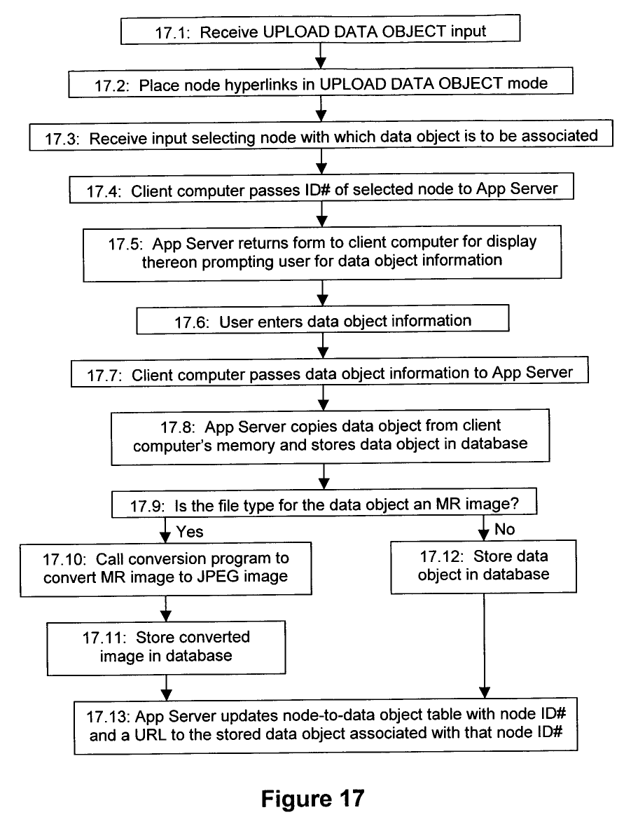

FIG. 17 is a flowchart illustrating the algorithm for associating a node with a data object and uploading the data object to the database. At Step 17.1, the client computer receives “upload data object” input from the user. As stated, a user can provide such input by selecting the UPLOAD DATA OBJECT icon displayed on the client computer screen. At Step 17.2, the client computer places the tree structure node hyperlinks and “add data object” to mode. Next, at Step 17.3, the client computer receives input from the user that identifies the node with which the data object is to be associated. Then, at Step 17.4 the client computer passes the ID# of the selected node to the application server.

After receiving the ID# of the selected node, the application server returns an interactive form to the client computer for a display thereon that prompts the user for information about the data object to be associated with the selected node (Step 17.5). At Step 17.6, the user enters information for the data object. Preferably this step comprises having the user enter the location where the data object is stored on the user's client computer. Once the user has entered the data object's storage location, the user can select an UPLOAD icon provided on the interactive form that is operative to pass the data object's client computer storage location to the application server (Step 17.7). Thereafter, at Step 17.8, the application server copies the data object from the specified location and stores a copy of the data object in the database. Next, at Step 17.9, the application server updates the node to data object table with the NodeID of the selected node and a pointer (preferably a URL) to the location of the data object in the database. After this process is complete, a user is then able to view the uploaded data object by selecting the node with which that data object is associated. Preferably, the node's name is a name that will meaningfully identify the data object associated therewith, which allows a user to easily associate nodes with their corresponding data object. For example, if the data object is a photo of the Smith family, it would be preferred that the name of the node associated therewith be “Smith Family Photo” or the like.

After the application server has copied the data object from the client computer's memory, at Step 17.9 the application server checks whether the file type for that data object is a magnetic resonance (MR) image. It should be noted that a major potential application for the present invention is as a data sharing tool for those in the medical profession. Medical professionals may use the present invention to efficiently exchange medical information, such as MRI images, X-rays and the like. If the data object is an MR image, the application server proceeds to Step 17.1 and calls a conversion program that converts the MR image to a JPEG image. Such conversion programs are known in the art, for example the Dicom conversion program is widely used. Thereafter, at Step 17.11, the application server stores the converted image in the database. If Step 17.19 results in a determination that the file type for the data object is not an MR image, then the application server can proceed to Step 17.12 and store the data object in the database.

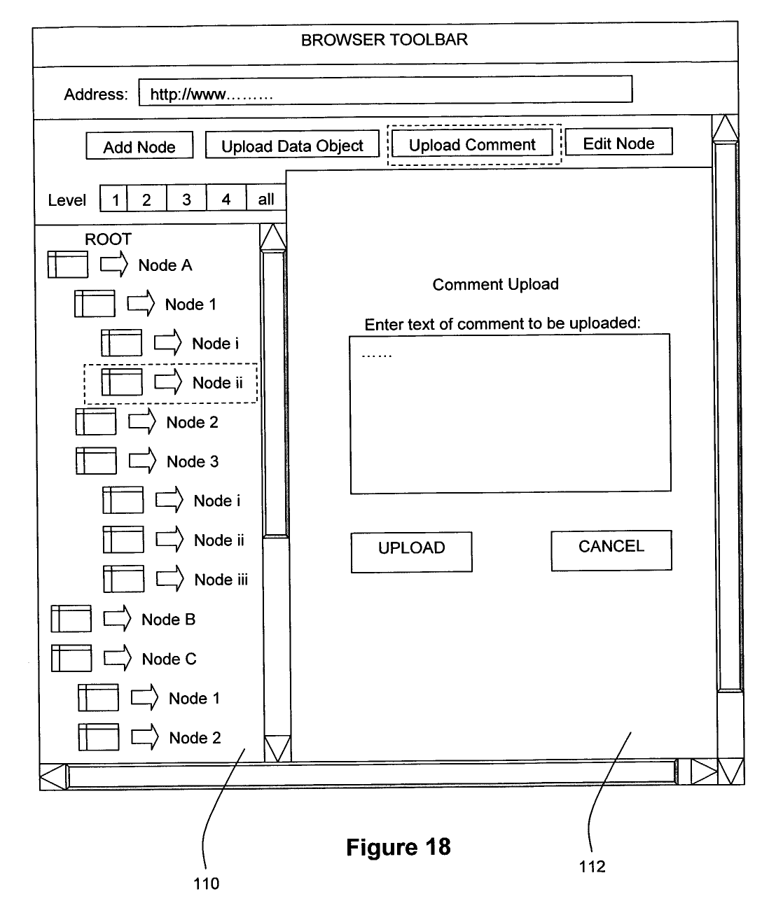

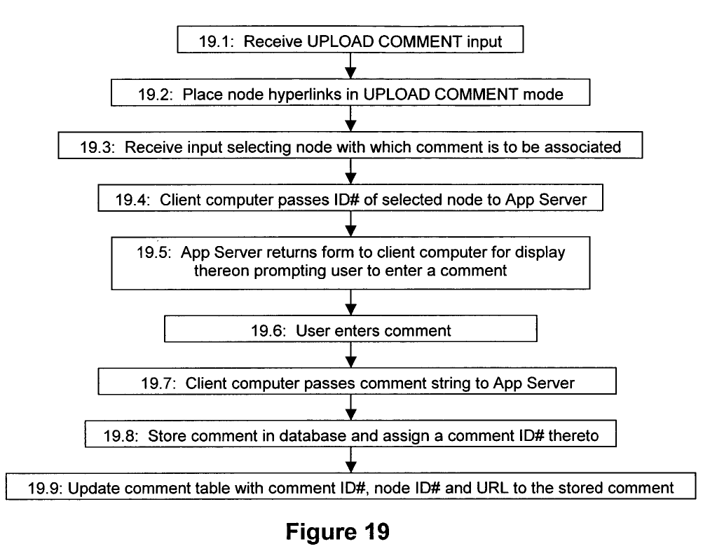

As noted above, a feature of the present invention is the ability of users to add comments to the data objects associated with the nodes of the tree structure. As stated, it is preferred that any commentary provided upon a data object is displayed along with the data object when the node associated with that data object is selected. To upload a comment to the database and associate that comment with a node, a user can select an UPLOAD COMMENT icon displayed on the client computer, as shown in FIG. 18 by the dashed box surrounding the UPLOAD COMMENT icon. Thereafter, the user can select the node with which the new comment is to be associated by selecting a node in the tree structure viewing frame 110 (as indicated by the dashed box surrounding one of the nodes in FIG. 18). Upon the selection of a node with which a comment is to be associated, an interactive form for uploading a comment is provided in viewing frame 112 as shown in FIG. 18. Preferably, the interactive comment uploading form includes a space in which the user can enter the text of the comment and an UPLOAD icon to be selected when the user wishes to upload the comments to the database. While it is preferred that the ability of a user to add comments to nodes is not restricted (a user is preferably able to post a comment to any of thee data objects associated with the group's tree structure), the system can be configured such that the ability of a user to post comments is limited to only particular nodes.

FIG. 19 is a flowchart illustrating the algorithm for adding a comment to the database. At Step 19.1, the client computer receives “upload comment” input from the user. Then, at Step 19.2, the client computer places the tree structure's node hyperlinks in an “upload comment” mode. Then at Step 19.3, the client computer receives input corresponding to a selection of a node with which the new comment is to be associated. At Step 19.4, the client computer passes the ID# of the selected node to the application server.

Thereafter, at Step 19.5, the application server returns an interactive form to the client computer for display thereon in viewing frame 112 that prompts the user to enter a comment. After the user enters the text of the comment in the interactive form (Step 19.6), the client computer passes the text of the comment to the application server (Step 19.7). Once in receipt of the comment, the application server stores the comment in the database and assigns a unique CID# thereto (Step 19.8). Then, at Step 19.9, the application server updates the comment table with the CID#, the node ID# received at Step 19.4, and a pointer (preferably a URL) to the location in the database of the stored comment. Once the comment uploading process is complete, that uploaded comment will be displayed along with its associated data object when the node associated therewith is selected.

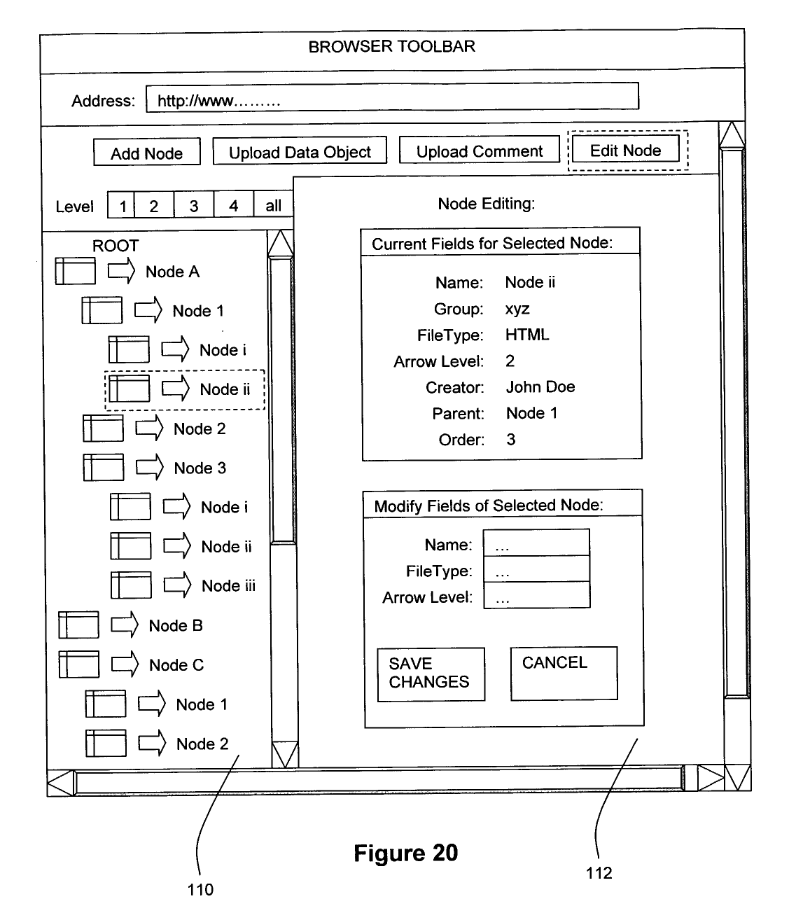

Another feature of the present invention is the ability of users to edit the fields of the nodes of the tree structure. As shown in FIG. 20, by selecting the EDIT NODE icon displayed on the client computer and then selecting a particular node displayed on the tree structure in the tree structure viewing frame 110, an interactive form can be provided to the user for editing the modifiable fields of the nodes. Preferably, a portion of the interactive form displays the current fields for the selected node. In FIG. 20, it can be seen that the node labeled “Node ii” under Node A has been selected by the user (as indicated by the dashed box surrounding Node ii). The interactive form shown in viewing frame 112 includes a portion that shows the current fields for Node ii (node name, file type, arrow level, creator, parent, order, and group ID). Preferably, the only modifiable fields for the nodes are the Node Name, field type, and arrow level. Another portion of the interactive form is provided for entering modifications to those fields. Once a user has entered the desired modifications, those modifications can be saved to the node database by selecting the saved changes icon.

As noted above in connection with the node addition and data object addition features of the present invention, the ability of a user to edit the fields of a node can be restricted to only those nodes where the user's MemberID is the same as the node's CreatorID field, to thereby prevent users from modifying nodes for which they are not the creator. It should also be noted that while the group administrator can restrict the ability to add data objects to nodes or edit nodes to only those users associated with the node, the administrator can also create a “common node” within the tree structure that all users in the group can add data objects to or edit.

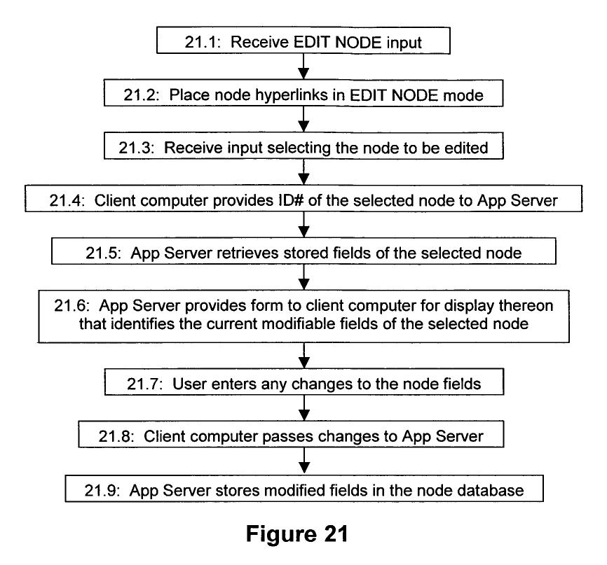

FIG. 21 is a flowchart illustrating the algorithm for editing a selected node. At Step 21.1, a client computer receives “edit node” input from a user. Next, at Step 21.2, the client computer places the tree structure node hyperlinks in an “edit node” mode. Thereafter, at Step 21.3, the client computer receives input from the user corresponding to a selection of the node to be edited. After receiving such input, the client computer provides the ID# of the selected node to the application server (Step 21.4).

In response to receiving the ID# of the selected node, the application server retrieves the fields stored in the node array that correspond to the ID# of the selected node. Then, at Step 21.6, the application server provides an interactive form to the client computer for display thereon that allows the user to modify the modifiable fields of the selected node. Preferably this interactive form is as shown in viewing frame 112 of FIG. 20. The preferable form includes a portion wherein the current fields for the selected nodes are displayed and another portion which allows a user to enter changes to the modifiable fields of the selected node. After the user enters any changes to the modifiable node fields (Step 21.7), the client computer passes those changes to the application server (Step 21.8). Once in receipt of these changes, the application server, at Step 21.9, stores the modified fields in the node database to thereby edit the selected node.

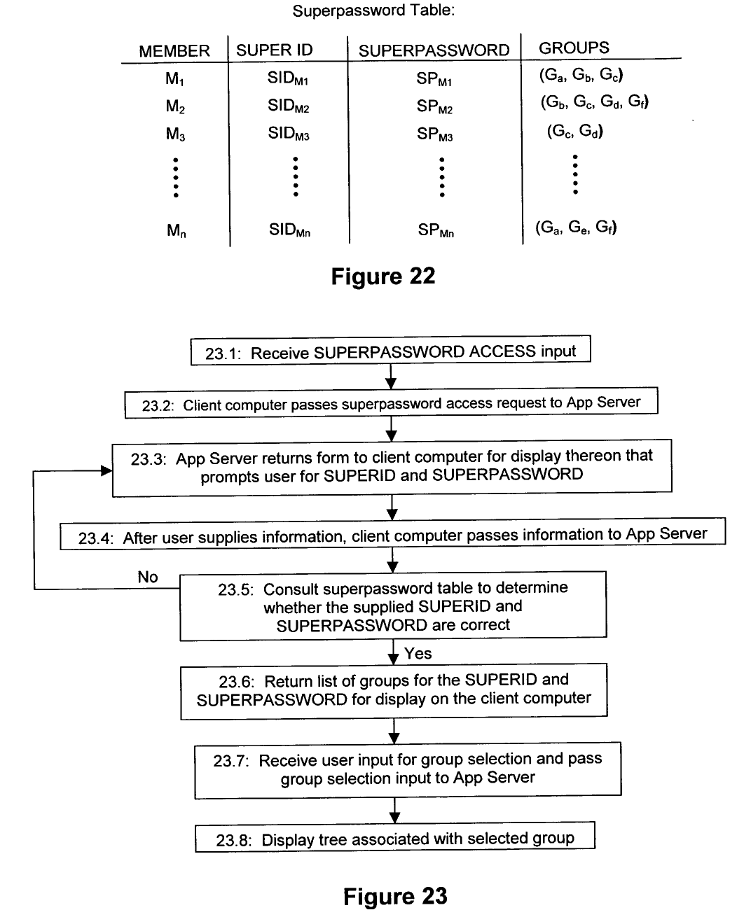

While the node addition, data object uploading, comment uploading, and node editing features of the present invention have been described in connection with interactive forms separately displayed in viewing frame 112, the present invention may be readily modified such that any combination of those tasks are combined in a single interactive form presented to the client computer user. As such, the icons in the toolbar associated with adding nodes, uploading data objects, uploading comments, and editing nodes can be modified to reflect such changes in the interactive form. By combining the different tasks in the same form, a user will be able to perform multiple operations in a single uploading action. An additional feature of the present invention is a superpassword function wherein a user who is a member of more than one group and who has different passwords in each of those groups can obtain a single password that provides access to all groups of which he is a member. The superpassword then serves as a master key for gaining access to any group of which the user is a member. FIG. 22 illustrates a table showing a list of members and their respective SuperIDs and superpasswords. Each entry in the superpassword table also identifies the groups for which access is consolidated with the superpassword. The application server can be configured to consult the super password table when processing the superpassword access input supplied by a user. Thus, if member 1 who belongs to both groups a, b, and c possesses different passwords Pₐ, P_{b}, and PC for those three groups respectively, a SuperID SID_{MI} and a superpassword SP_{MI} can be created for member 1 that allows member 1 to gain access to any of the groups a, b, and c.

FIG. 23 is a flowchart illustrating an algorithm for logging a user onto the system when the application server is configured with a super password function. At Step 23.1, the client computer receives input from a user indicating that the user wants to access the invention using a superpassword. In Step 23.2, the client computer passes the superpassword access request to the application server, and the application server responds by returning a form to the client computer for display thereon that prompts the user for the user's SuperID and superpassword (Step 23.3). After the user supplies the requested information, the client computer passes that information to the application server (Step 23.4).

At Step 23.5, the application server processes the SuperID and superpassword supplied by the user. If the application server finds that the SuperID and superpassword provided by the user properly correspond with each other, the application server proceeds to Step 23.6 and checks the superpassword table to identify the groups encompassed by the SuperID and superpassword. Having identified the groups, those groups are returned as a list to the client computer for display thereon. At step 23.7, the application server awaits user input corresponding to a selection of one of the listed groups. Once group selection input is received, the application server proceeds to Step 23.8 and displays the group's tree structure. If the SuperID and superpassword information provide by the user at Step 23.5 is incorrect, then the application server returns to Step 23.3.

The super password feature of the present invention alleviates the need for users who are members of more than one group to remember a multitude of passwords. Rather than requiring a user to remember all passwords for the groups of which he is a member, the user need only remember the single super password provided to him. Preferably, the creation of super passwords is limited to group administrators. However, this need not be the case.

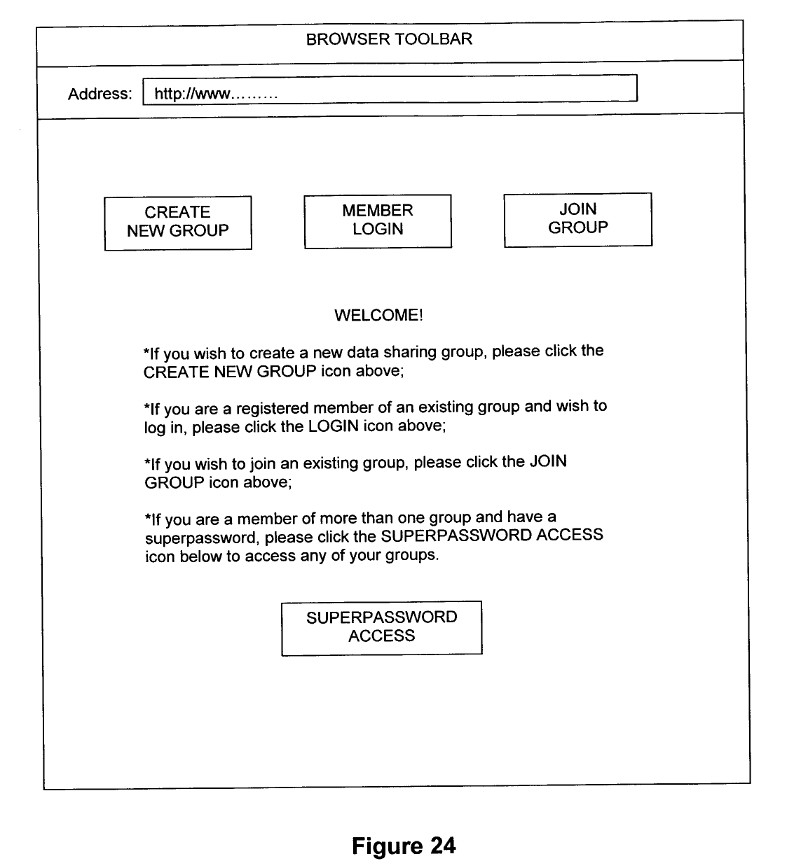

The data sharing system of the present invention also allows users to create new data sharing groups. FIG. 24 is a client computer screen shot of an initial page that can be displayed when a user accesses a website implementing the present invention. This initial page displays icons that allow a user to begin the process of either creating a new group, logging in to an existing group (if the user is a registered member) using traditional memberID and password access, joining an existing group, or logging in via the above-described superpassword access feature of the present invention.

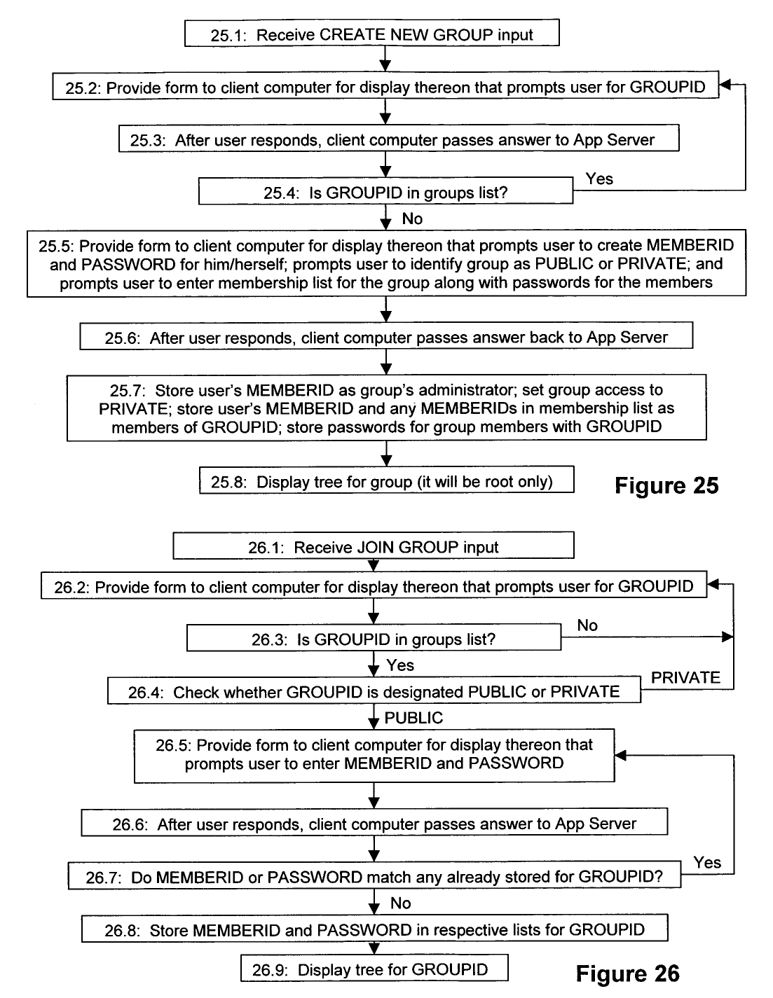

FIG. 25 is a flowchart illustrating the algorithm for creating a new group. At Step 25.1, the application server receives “create new group” input from the client computer. Preferably, the client computer provides such input to the application server when a user has selected a CREATE NEW GROUP icon displayed on the client computer screen. At Step 25.2, the application server provides a form to the client computer for display thereon that prompts the user to enter a name for the group (GroupID). After the user responds, the client computer passes the GroupID to the application server (Step 25.3). At Step 25.4, the application server checks whether the GroupID provided by the user is already presents in the list of existing groups. If it is, the application server loops back to Step 25.2 and reprompts the user for a different group name. If the GroupID provided by the user is not present in the list of existing groups, and the application server proceeds to Step 25.5 wherein it provides a form to client computer for display thereon that prompts the user to create a MemberID and password for himself or herself, identify the group as public or private, and enter a membership list for the group along with passwords for the members identified in the membership list. By designating the group “public”, there will be no restrictions on who may join the group. If the group is designated “private”, membership in the group will be restricted to those members identified in the membership list provided by the group's administrator. The group administrator preferably is also able to update the group's membership list to include new members. After the user completes the form, the client computer passes the information supplied by the user back to the application server (Step 25.6). Thereafter, at Step 25.7, the application server stores the user's MemberID as the group administrator, sets the group's access to either public or private depending upon the user's designation, and stores the user's MemberID and any MemberIDs in the membership list provided by the user as the membership list for GroupID, and stores the passwords for the group members in the password list for GroupID. Thereafter, at Step 25.8, the application server proceeds with a tree display algorithm (which will initially only display a root).

It should be noted that it is preferable for group administrators to possess greater control over the attributes of a group. For example, group administrators are preferably provided with the ability to modify the group's membership list, modify the group's password list, create super passwords, and perform any of the above described functions of adding nodes, uploading data objects, uploading comments and editing nodes on any node of the group's tree structure.

The present invention also allows users who are new to the data sharing system of the present invention to join a public group without the intervention of a group administrator. FIG. 26 is a flowchart illustrating an algorithm through which a user can join a public group. At Step 26.1, the application server receives “join group” input from the client computer. Preferably, the client computer provides such input to the application server in response to a user clicking a JOIN GROUP icon displayed on the client computer screen, as shown in FIG. 24. At Step 26.2, the application server provides a form to the client computer for display thereon that prompts the user to enter the name of the group that the user wishes to join (GroupID). After the user responds and the client computer has passed the GroupID provided by the user to the application server, at Step 26.3, the application server checks whether the GroupID provided by the user is present in the list of existing groups. If it is not, the application server loops back to Step 26.2 and reprompts the user for a different group name. If the GroupID provided by the user is in the list of existing groups, then the application server proceeds to Step 26.4 wherein it checks whether the GroupID is designated as public or private. If the group ID is designated as private, the application server loops back to Step 25.2 after notifying the user that membership in that group is restricted. If the GroupID is public, the application server proceeds to Step 26.5 and provides a form for the client computer for display thereon that prompts the user to enter a MemberID and password. After the user supplies such information, the client computer passes the answer back to the application server (Step 26.6). Then, at Step 26.7, the application server checks whether the MemberID or password provided by the user match any already stored for GroupID. If desired, the application server can also check whether the MemberID or password provided by the user match any of the member IDs or passwords stored for any of the groups in the database. If Step 26.7 determines that there is a match, the application server loops back to Step 26.6 and re-prompts the user to enter a different MemberID or password. If Step 26.7 determines that there is not a match, then the application server proceeds to Step 26.8 and stores the MemberID and password provided by the user in the respective lists for GroupID. The user is now a member of that group. Thereafter, at Step 26.9, the application server prompts the tree display algorithm of FIGS. 6 and 7.

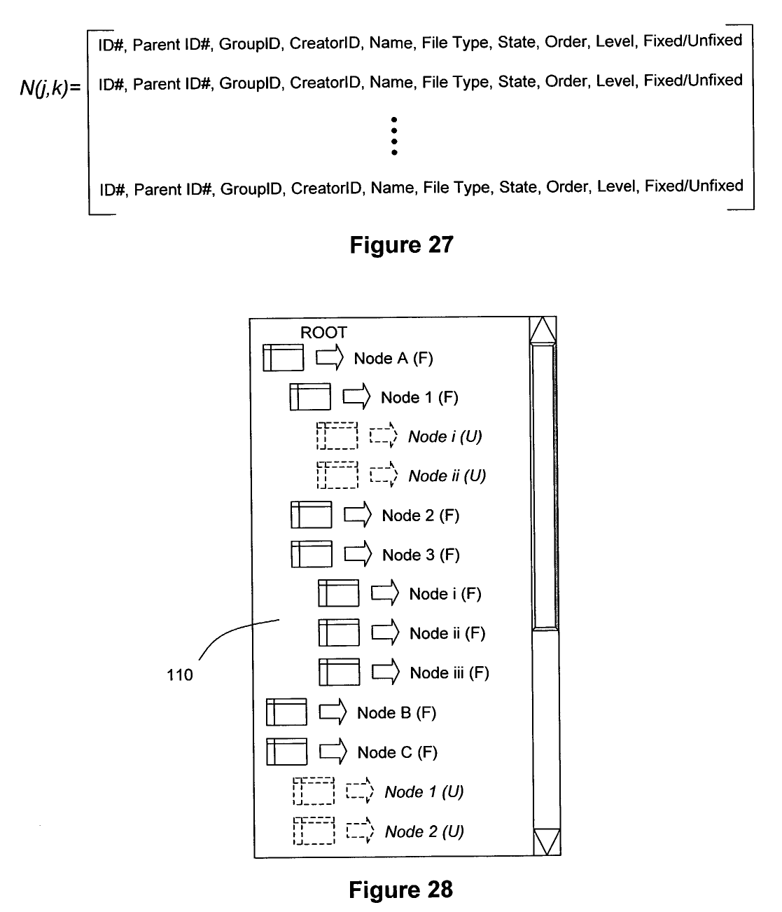

Another feature of the present invention is the ability of a group administrator to create a partially-fixed tree structure. Nodes of such a partially-fixed tree structure include a field that identifies whether a particular node is FIXED or UNFIXED. FIG. 27 illustrates the node array for such a partially-fixed tree structure.

The group administrator preferably creates a fixed tree structure comprised of a plurality of fixed nodes. Fixed nodes are nonmodifiable by other members of the group. Also, other members of the group may only add unfixed nodes beneath fixed nodes. Thus, the fixed tree structure serves as a frame into which group members may include additional unfixed nodes. Such a partially-fixed tree structure is easily implemented with minor modifications made to the node addition process described above wherein a new node may only be added to the tree structure if such a new node has a fixed node as a parent. Also, it will often be the case when the partially-fixed tree structure is used that each fixed node have a limited number of members eligible to add unfixed child nodes thereto. For example, each fixed node may be restricted such that only one particular group member is permitted to add subnodes thereto. Such control can be implemented by adding an additional field to each node in the node array; a field that identifies each member eligible use that node as the parent node of a new node. The node addition process would then be modified to check whether the user attempting to add a node beneath a particular parent node is allowed to do so by examining the member eligibility field of the parent node.

In the tree structure viewing frame 110 of FIG. 28, an exemplary partially-fixed tree structure is shown. Nodes shown in solid lines are fixed nodes while nodes shown in dashed lines are unfixed nodes. As can be seen, all unfixed nodes are children of fixed nodes. An unfixed node is not permitted to be the parent of a fixed node. Thus, users are free to add nodes beneath Node A, Node 1, Node 2, Node 3, Nodes i-iii descending from Node 3, Node B, and Node C, but are not permitted to add a branch directly to the root.

By restricting the ability of users to add nodes such that nodes may only be added within a particular framework of fixed nodes, the group administrator can preserve some semblance of organizational control over the tree structure. For example, if a particular group using the present invention was a group of people with a shared interest in a particular topic who regularly trade papers, discussion, or articles on that topic, the administrator for that group may desire to create a fixed tree structure with fixed nodes that identify each of the member's names, and subnodes that serve as headings for the members' respective credentials, pertinent publications, and the like. Thereafter, each member would be free to add a node and associated data object identifying their credentials beneath the fixed node serving as a credential heading and one or mode nodes and associated data objects containing various scholarly papers and the like beneath the fixed node serving as a publication header. This example is illustrative only, and the present invention's partially-fixed tree structure format can be used in a variety of useful ways by group administrators to organize a group's data, as would be understood by those of ordinary skill in the art.

Another feature of the present invention is the ability of a group administrator to create a partially-fixed tree structure. Nodes of such a partially-fixed tree structure include a field that identifies whether a particular node is FIXED or UNFIXED. FIG. 27 illustrates the node array for such a partially-fixed tree structure.

The group administrator preferably creates a fixed tree structure comprised of a plurality of fixed nodes. Fixed nodes are nonmodifiable by other members of the group. Also, other members of the group may only add unfixed nodes beneath fixed nodes. Thus, the fixed tree structure serves as a frame into which group members may include additional unfixed nodes. Such a partially-fixed tree structure is easily implemented with minor modifications made to the node addition process described above wherein a new node may only be added to the tree structure if such a new node has a fixed node as a parent. Also, it will often be the case when the partially-fixed tree structure is used that each fixed node have a limited number of members eligible to add unfixed child nodes thereto. For example, each fixed node may be restricted such that only one particular group member is permitted to add subnodes thereto. Such control can be implemented by adding an additional field to each node in the node array; a field that identifies each member eligible use that node as the parent node of a new node. The node addition process would then be modified to check whether the user attempting to add a node beneath a particular parent node is allowed to do so by examining the member eligibility field of the parent node.

In the tree structure viewing frame 110 of FIG. 28, an exemplary partially-fixed tree structure is shown. Nodes shown in solid lines are fixed nodes while nodes shown in dashed lines are unfixed nodes. As can be seen, all unfixed nodes are children of fixed nodes. An unfixed node is not permitted to be the parent of a fixed node. Thus, users are free to add nodes beneath Node A, Node 1, Node 2, Node 3, Nodes i-iii descending from Node 3, Node B, and Node C, but are not permitted to add a branch directly to the root.

By restricting the ability of users to add nodes such that nodes may only be added within a particular framework of fixed nodes, the group administrator can preserve some semblance of organizational control over the tree structure. For example, if a particular group using the present invention was a group of people with a shared interest in a particular topic who regularly trade papers, discussion, or articles on that topic, the administrator for that group may desire to create a fixed tree structure with fixed nodes that identify each of the member's names, and subnodes that serve as headings for the members' respective credentials, pertinent publications, and the like. Thereafter, each member would be free to add a node and associated data object identifying their credentials beneath the fixed node serving as a credential heading and one or mode nodes and associated data objects containing various scholarly papers and the like beneath the fixed node serving as a publication header. This example is illustrative only, and the present invention's partially-fixed tree structure format can be used in a variety of useful ways by group administrators to organize a group's data, as would be understood by those of ordinary skill in the art.

The present invention described above thus represents highly useful system for sharing data among a plurality of users via a computer network such as the Internet that possesses a degree of flexibility and user-friendliness not found in the prior art.

While the invention has been described above in relation to its preferred embodiment, various modifications may be made thereto that still fall within the invention's scope, as would be recognized by those of ordinary skill in the art upon review of the teachings herein. As such, the scope of the present invention is to be defined by the appended claims in view of the description above and figures discussed herein.

What is claimed is:

1. A computer system for sharing information among a plurality of users, the computer system comprising:
a database having content stored therein, the content comprising (1) a plurality of data objects and (2) a user-configurable tree structure comprising a plurality of selectable nodes that index the data objects;
at least one client computer in communication with a global computer network, each client computer having a display screen on which the client computer is configured to display data to a user; and
an application server in communication with the database and the network, the application server being configured to (1) send at least a portion of the tree structure over the network to a client computer at least partially in response to an access request received over the network from a client computer, (2) cause the client computer to display the tree structure sent thereto in a viewing frame of the client computer's display screen, (3) receive node selection input from the client computer that corresponds to a selection of a node of the displayed tree structure by the user of the client computer, (4) provide the data object indexed by the selected node to the client computer for display thereon in another viewing frame of the client computer's display screen, wherein both of the viewing frames are co-displayed on the client computer's display screen; (5) receive modification input from the client computer that corresponds to a modification of the content of the database including the tree structure, and (6) process the received modification input to thereby appropriately modify the content of the database.

2. The system of claim 1 wherein the plurality of selectable nodes comprising the tree structure are organized in a hierarchical manner starting from a root node, and wherein the application server is further configured to add a node to the tree structure at least partially in response to received modification input that corresponds to a node addition request from the user.

3. The system of claim 2 wherein the application server is further configured to add a plurality of nodes to the tree structure simultaneously at least partially in response to received modification input that corresponds to a multiple node addition request from the user.

4. The system of claim 2 wherein the application server is further configured to add a data object to the content of the database at least partially in response to received modification input that corresponds to a data object addition request from the user.

5. The system of claim 4 wherein the application server is further configured to associate a node with a data object at least partially in response to received modification input that corresponds to a data object-to-node association request from the user.

6. The system of claim 5 wherein the content of the database further comprises a plurality of comments, each comment being associated with a data object, and wherein the application server is further configured to provide each comment associated with the data object indexed by the selected node to the client computer for display thereon along with the displayed data object.

7. The system of claim 6 wherein the application server is further configured to add (1) a comment to the content of the database and (2) associate the added comment with a data object, the comment addition and comment association being made at least partially in response to received modification input that corresponds to a comment addition request and a comment association request.

8. The system of claim 7 wherein the application server is further configured to delete a node from the tree structure at least partially in response to received modification input that corresponds to a node deletion request from the user.

9. The system of claim 7 wherein each node has a plurality of fields associated therewith, including a name field for storing a name for the node, and wherein the displayed tree structure comprises a plurality of hyperlinks corresponding to the nodes of the tree structure, each hyperlink identifying the name stored in the name field of the node corresponding thereto.

10. The system of claim 7 wherein the application server is further configured to modify at least one field of a node at least partially in response to received modification input that corresponding to a node editing request from the user.

11. The system of claim 2 wherein each node for which there is a descendant node is associated with a user-configurable level selection value, and wherein the application server is further configured to (1) receive tree structure redisplay input from the client computer, the tree structure redisplay input identifying a node as the root node from which the tree structure is to be redisplayed, (2) cause the client computer to redisplay the tree structure in the tree structure viewing frame using the node identified by the tree structure redisplay input as the root node wherein the redisplayed tree structure is limited to nodes that are descendants of the root node within a number of generations equal to the level selection value associated with the root node.

12. The system of claim 11 wherein the content of the database further comprises each level selection value, and wherein the application server is further configured to adjust a stored level selection value at least partially in response to received modification input that corresponds to a level selection value adjustment request from the user.

13. The system of claim 2 wherein at least a portion of the data objects stored in the database are image files, and wherein the application server is further configured to, when an image file is displayed on the client computer's display screen, send a program over the network to the client computer for execution thereon, the program being executable to modify how the image file is displayed on the client computer's display screen.

14. The system of claim 13 wherein the program is executable to modify how the image file is displayed on the client computer's display screen by adjusting the scale of the displayed image file at least partially in response to a scale adjustment input provided by the user.

15. The system of claim 13 wherein the program is further executable to modify how the image file is displayed on the client computer's display screen by adjusting the contrast of the displayed image file at least partially in response to a contrast adjustment input provided by the user.

16. The system of claim 13 wherein at least one node indexes a plurality of image files, and wherein the application server is further configured to, in response to receiving node selection input corresponding to a selection of a node that indexes a plurality of image files, provide each image file indexed by the selected node to the client computer for simultaneous display thereon in the data object viewing frame.

17. The system of claim 9 wherein at least a plurality of the data objects stored in the database are magnetic resonance imaging (MRI) files.

18. The system of claim 17 wherein the application server is further configured to add an MRI file to the content of the database at least partially in response to received modification input that corresponds to an MRI file addition request by (1) converting the received MRI file to a pre-determined format and (2) storing the converted MRI file in the database.

19. The system of claim 18 wherein at least one node of the tree structure that indexes an MRI file has the name of the patient depicted in the MRI file stored in its name field.

20. The system of claim 9 wherein at least a plurality of the data objects stored in the database are files having genealogical information about a family.

21. The system of claim 20 wherein at least one node of the tree structure that indexes a genealogical file has a family member name or family surname stored in its name field.

22. The system of claim 2 wherein the content of the database further comprises a plurality of tree structures, each tree structure being associated with a different group, each group having a plurality of members and a group administrator, each group member having a password for accessing the data objects indexed by the nodes of the tree structure associated with that group member's group, wherein at least one user is a member of more than one group, and wherein the application server is further configured to allow a group administrator to create a superpassword for a group member who is a member of more than one group, the superpassword providing access to the data objects indexed by the nodes of the tree structures associated with all of that group member's groups.

23. The system of claim 2 wherein the application server is further configured to send output over the network to the client computer that corresponds to an identification of a format for a data object that is to be displayed in the data object viewing frame, to thereby enable the client computer to call a program stored thereon suitable for opening and displaying that data object.

24. The system of claim 2 wherein the application server is a home-based personal computer.

25. The system of claim 2 wherein the content of the database further comprises a plurality of tree structures, each tree structure being associated with a different group, each group having a plurality of members and a group administrator, and wherein the application server is further configured to allow each group administrator to designate a plurality of the nodes of the group's tree structure as fixed.

26. A method of sharing information among a plurality of users, the method comprising:
storing a plurality of data objects in a database;
storing a tree structure in the database, the tree structure comprising a plurality of selectable nodes that index the stored data objects;
executing software stored on an application server that interfaces the database with a client computer, the application server being in communication with the client computer via a global computer network, the client computer having a display screen on which the client computer is configured to display data to a user, wherein the software execution comprises: (1) providing the tree structure over the network to the client computer at least partially in response to an access request received over the network from the client computer, (2) causing the client computer to display the tree structure provided thereto in a viewing frame of the client computer's display screen, (3) receiving node selection input from the client computer that corresponds to a selection of a node of the displayed tree structure by the user of the client computer, (4) providing the data object indexed by the selected node to the client computer for display thereon in another viewing frame of the client computer's display screen, wherein both of the viewing frames are co-displayed on the client computer's display screen; (5) receiving modification input from the client computer that corresponds to a modification of the database including the tree structure stored therein, and (6) processing the received modification input to thereby appropriately modify the database.

27. The method of claim 26 wherein the plurality of selectable nodes comprising the tree structure are organized in a hierarchical manner starting from a root node, and wherein the processing step comprises adding a node to the tree structure at least partially in response to received modification input that corresponds to a node addition request from the user.

28. The method of claim 27 wherein the processing step further comprises adding a plurality of nodes to the tree structure simultaneously at least partially in response to received modification input that corresponds to a multiple node addition request from the user.

29. The method of claim 27 wherein the processing step further comprises adding a data object to the database at least partially in response to received modification input that corresponds to a data object addition request from the user.

30. The method of claim 29 wherein the processing step further comprises associating a node with a data object at least partially in response to received modification input that corresponds to a data object-to-node association request from the user.

31. The method of claim 30 wherein the processing step further comprises adding a comment to the database at least partially in response to received modification input that corresponds to a comment addition request from the user, the comment being associated with a data object such that it is to be displayed therewith.

32. The method of claim 31 wherein the processing step further comprises deleting a node from the tree structure at least partially in response to received modification input that corresponds to a node deletion request from the user.

33. The method of claim 31 wherein each node has a plurality of fields associated therewith, including a name field in which a name for the node is stored, and wherein the displayed tree structure comprises a plurality of hyperlinks corresponding to the nodes of the tree structure, each hyperlink identifying the name stored in the name field of the node corresponding thereto.

34. The method of claim 33 wherein the processing step further comprises modifying at least one field of a node at least partially in response to received modification input that corresponding to a node editing request from the user.

35. The method of claim 27 wherein each node for which there is a descendant node is associated with a user-configurable level selection value, and wherein the software execution step further comprises (1) receiving tree structure redisplay input from the client computer, the tree structure redisplay input identifying a node as the root node from which the tree structure is to be redisplayed, and (2) causing the client computer to redisplay the tree structure in the tree structure viewing frame using the node identified by the tree structure redisplay input as the root node, wherein the redisplayed tree structure is limited to nodes that are descendants of the root node within a number of generations equal to the level selection value associated with the root node.

36. The method of claim 35 wherein the content of the database further comprises each level selection value, and wherein the processing step further comprises adjusting a stored level selection value at least partially in response to received modification input that corresponds to a level selection value adjustment request from the user.

37. The method of claim 27 wherein at least a portion of the data objects stored in the database are image files, and wherein the software execution step further, when an image file is to be displayed on the client computer's display screen, sending a program over the network to the client computer for execution thereon, the program being executable to modify how the image file is displayed on the client computer's display screen.

38. The method of claim 37 wherein at least one node indexes a plurality of image files, and wherein the software execution step further comprises, in response to receiving node selection input corresponding to a selection of a node that indexes a plurality of image files, providing each image file indexed by the selected node to the client computer for simultaneous display thereon in the data object viewing frame.

39. The method of claim 33 wherein at least a plurality of the data objects stored in the database are magnetic resonance imaging (MRI) files.

40. The method of claim 39 wherein the processing step further comprises adding an MRI file to the database at least partially in response to received modification input that corresponds to an MRI file addition request, the MRI file adding step comprising (1) converting the received MRI file to a pre-determined format and (2) storing the converted MRI file in the database.

41. The method of claim 40 wherein at least one node of the tree structure that indexes an MRI file has the name of the patient depicted in the MRI file stored in its name field.

42. The method of claim 33 wherein at least a plurality of the data objects stored in the database are files having genealogical information about a family.

43. The method of claim 42 wherein at least one node of the tree structure that indexes a genealogical file has a family member name or family surname stored in its name field.

44. The method of claim 27 wherein the database further comprises a plurality of tree structures, the method further comprising associating each tree structure with a different group, each group having a plurality of members and a group administrator, each group member having a password for accessing the data objects indexed by the nodes of the tree structure associated with that group member's group, wherein at least one user is a member of more than one group, and wherein the software execution step further comprises allowing a group administrator to create a superpassword for a user who is a member of more than one group, the superpassword providing access to the data objects indexed by the nodes of the tree structures associated with all of that user's groups.

45. The method of claim 27 wherein the software execution step further comprises sending output over the network to the client computer that corresponds to an identification of a format for a data object that is to be displayed in the data object viewing frame, to thereby enable the client computer to call a program stored thereon suitable for opening and displaying that data object.

46. The method of claim 27 wherein the database further comprises a plurality of tree structures, the method further comprising associating each tree structure with a different group, each group having a plurality of members and a group administrator, and wherein the software execution step further comprises allowing each group administrator to designate a plurality of the nodes of the group's tree structure as fixed.

47. A computer-readable medium for accessing information stored in a database and sharing that information over a global computer network among a plurality of users, the computer-readable medium comprising:
one or more instructions executable by a processor for maintaining a tree structure comprising a plurality of selectable nodes that index a plurality of data objects stored in the database;
one or more instructions executable by a processor for sending at least a portion of the tree structure of the network to a client computer for display thereon, the client computer having a display screen and being configured to display the portion of the tree structure sent thereto in a tree structure viewing frame of the display screen;
one or more instructions executable by a processor for interfacing with the client computer including (1) one or more instructions for obtaining input corresponding to a selection of a node of the tree structure by a user of the client computer, and (2) one or more instructions for obtaining input corresponding to a request by the user to modify the tree structure;
one or more instructions executable by a processor for retrieving from the database the data object that is indexed by the node identified by node selection input obtained from the user;
one or more instructions executable by a processor for sending the retrieved data object over the network to the client computer for display thereon in a data object viewing frame of the client computer's display screen, the tree structure viewing frame and the data object viewing frame being displayed at the same time in a nonoverlapping manner; and
one or more instructions executable by a processor for modifying the tree structure at least partially according to tree structure modification input obtained from the user.

48. The computer-readable medium of claim 47 wherein the plurality of selectable nodes comprising the tree structure are organized in a hierarchical manner starting from a root node, and wherein the one or more instructions executable by a processor for modifying the tree structure include one or more instructions for adding a node to the tree structure at least partially in response to tree structure modification input obtained from the user that corresponds to a node addition request.

49. The computer-readable medium of claim 48 wherein the one or more instructions executable by a processor for modifying the tree structure include one or more instructions for adding a plurality of nodes to the tree structure simultaneously at least partially in response to tree structure modification input obtained from the user that corresponds to a multiple node addition request.

50. The computer-readable medium of claim 48 wherein the one or more instructions executable by a processor for interfacing with the client computer further include one or more instructions for obtaining input corresponding to a request by the user to modify the database, the computer-readable medium further comprising one or more instructions executable by a processor for adding a data object to the database at least partially in response to database modification input obtained from the user that corresponds to a data object addition request.

51. The computer-readable medium of claim 50 further comprising one or more instructions executable by a processor for associating a data object with a node at least partially in response to database modification input obtained from the user that corresponds to a data object-to-node association request.

52. The computer-readable medium of claim 51 wherein the information stored in the database further comprises a plurality of comments, each comment being associated with a data object, the computer-readable medium further comprising one or more instructions executable by a processor for (1) retrieving each comment associated with the data object indexed by the selected node and (2) sending each retrieved comment to the client computer for display thereon along with the displayed data object.

53. The computer-readable medium of claim 52 further comprising one or more instructions executable by a processor for adding a comment to the database at least partially in response to database modification input obtained from the user that corresponds to a comment addition request.

54. The computer-readable medium of claim 53 wherein the one or more instructions executable by a processor for modifying the tree structure include one or more instructions for deleting a node from the tree structure at least partially in response to tree structure modification input obtained from the user that corresponds to a node deletion request.

55. The computer-readable medium of claim 53 wherein each node has a plurality of fields associated therewith, including a name field for storing a name for the node, and wherein the displayed tree structure comprises a plurality of hyperlinks corresponding to the nodes of the tree structure, each hyperlink identifying the name stored in the name field of the node corresponding thereto.

56. The computer-readable medium of claim 53 wherein the one or more instructions executable by a processor for modifying the tree structure include one or more instructions for modifying at least one field of a node at least partially in response to tree structure modification input obtained from the user that corresponds to a node editing request.

57. The computer-readable medium of claim 48 wherein each node for which there is a descendant node is associated with a user-configurable level selection value, and wherein the one or more instructions executable by a processor for interfacing with the client computer further include one or more instructions for obtaining input corresponding to a request by the user to redisplay the tree structure using a particular node as the root node, the computer-readable medium further comprising one or more instructions executable by a processor for restricting which nodes are displayed in the redisplayed tree structure to those nodes that are descendants of the root node within a number of generations equal to the level selection value associated with the root node.

58. The computer-readable medium of claim 51 wherein the information stored in the database further comprises each level selection value, and the computer-readable medium further comprising one or more instructions executable by a processor for adjusting a stored level selection value at least partially in response to database modification input obtained from the user that corresponds to a level selection value adjustment request.

59. The computer-readable medium of claim 48 wherein at least a portion of the data objects stored in the database are image files, and wherein the computer-readable medium further comprises one or more instructions executable by a processor for, when an image file is to be displayed on the client computer's display screen, sending a program over the network to the client computer for execution thereon, the program being executable to modify how the image file is displayed on the client computer's display screen, the image file modification including at least one of the group consisting of scale adjustment and contrast adjustment.

60. The computer-readable medium of claim 59 wherein at least one node indexes a plurality of image files, the computer-readable medium further comprising one or more instructions executable by a processor for, when the node selection input obtained from the user corresponds a selection of a node that indexes a plurality of image files, (1) retrieving each image file indexed by the selected node and (2) sending each retrieved image file to the client computer for simultaneous display thereon in the data object viewing frame.

61. The computer-readable medium of claim 55 wherein at least a plurality of the data objects stored in the database are magnetic resonance imaging (MRI) files.

62. The computer-readable medium of claim 61 further comprising one or more instructions executable by a processor for adding an MRI file to the database at least partially in response to database modification input obtained from the user that corresponds to an MRI file addition request, the one or more instructions for adding an MRI file to the database including one or more instructions for (1) converting the MRI file to a pre-determined format and (2) storing the converted MRI file in the database.

63. The computer-readable medium of claim 55 wherein at least a plurality of the data objects stored in the database are files having genealogical information about a family.

64. The computer-readable medium of claim 48 wherein the information stored in the database further comprises a plurality of tree structures, each tree structure being associated with a different group, each group having a plurality of members and a group administrator, each group member having a password for accessing the data objects indexed by the nodes of the tree structure associated with that group member's group, wherein at least one user is a member of more than one group, the computer-readable medium further comprising one or more instructions executable by a processor for allowing a group administrator to create a superpassword for a user who is a member of more than one group, the superpassword providing access to the data objects indexed by the nodes of the tree structures associated with all of that user's groups.

65. The computer-readable medium of claim 48 further comprising one or more instructions executable by a processor for sending output over the network to the client computer that corresponds to an identification of a format for a data object that is to be displayed in the data object viewing frame, to thereby enable the client computer to call a program stored thereon suitable for opening and displaying that data object.

66. The computer-readable medium of claim 48 wherein the information stored in the database further comprises a plurality of tree structures, each tree structure being associated with a different group, each group having a plurality of members and a group administrator, the computer-readable medium further comprising one or more instructions executable by a processor for allowing each group administrator to designate a plurality of the nodes of the group's tree structure as fixed.

67. A computer-implemented method for sharing information over a network among a plurality of users, the method comprising:
forming a plurality of data sharing groups, each data sharing group comprising a plurality of members and having group data accessible to its members, wherein at least one user is a member of more than one data sharing group;
for each group, associating each member with a member identification and a password for gaining access to the data sharing group; and
for a user who is a member of more than one group, assigning thereto a super identification and a superpassword for gaining access to any of the data sharing groups if which that user is a member.

68. The method of claim 67 further comprising:
receiving a super identification and a superpassword from a user;
determining whether the received super identification and super password are valid;
if valid, providing the user with a list of data sharing groups to which access can be gained via the received superidentification and received superpassword;
receiving group selection input from the user corresponding to a listed data sharing group; and
providing the user with access to the data of the data sharing group corresponding to the group selection input.
